(19) United States
(12) Patent Application Publication
(10) Pub. No.: US 2008/0206616 A1
(43) Pub. Date: Aug. 28, 2008

(54) CATALYST COATED MEMBRANES AND SPRAYABLE INKS AND PROCESSES FOR FORMING SAME

(75) Inventors: Paolina Atanassova, Albuquerque, NM (US); James H. Brewster, Rio Rancho, NM (US); Lawrence V. Lucero, Rio Rancho, NM (US); Matthew C. Ezenyilimba, Sandia Park, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/679,758

(22) Filed: Feb. 27, 2007

(51) Int. Cl. H01M 8/10; B05D 1/02; B05D 3/00; C08K 5/05; C09D 11/00

(52) U.S. Cl. 429/30; 427/115; 429/12; 429/40; 524/386; 524/379

(57) ABSTRACT

The invention is directed to highly porous catalyst coated membranes and to sprayable inks and processes for forming catalyst coated membranes. In one aspect, the invention is to a sprayable ink, comprising catalyst particles, polymer electolyte ionomer, and a vehicle for dispersing the catalyst particles and polymer electolyte ionomer. In another aspect, the process comprises the steps of depositing an ink comprising catalyst particles and a vehicle onto a membrane and vaporizing from 40 to 95 weight percent of the vehicle from the sprayed ink under conditions effective to form a catalyst layer on the membrane. Preferably, the depositing and vaporizing steps are alternated to form multiple stacked catalyst layers on the membrane.

### BACKGROUND OF THE INVENTION

1. Field of the Invention

The invention relates to manufacturing of fuel cells. More particularly, the invention relates to catalyst coated membranes for use in fuel cells and to inks and processes for forming catalyst coated membranes.

2. Background Art

Fuel cells are electrochemical cells that convert reactants, namely fuel and oxidant fluid streams, to generate electric power and reaction products. A broad range of reactants can be used in fuel cells and such reactants may be delivered in gaseous or liquid streams. For example, the fuel stream may be substantially pure hydrogen gas, a gaseous hydrogen-containing reformate stream, or an aqueous alcohol, for example methanol in a direct methanol fuel cell (DMFC). The oxidant may, for example, be substantially pure oxygen or a dilute oxygen stream such as air.

DMFC's are particularly desirable for small electronic equipment applications. Non-limiting examples of such equipment include includes cellular and satellite phones, small portable music players, handheld personal computing/communicating devices (e.g., PDA, Blackberry®) among other types of devices. DMFC's are useful for these applications because of the high volumetric energy density of the methanol fuel and the potential of DMFC energy source to deliver significant advantages over batteries.

A DMFC fuel cell is one type of solid polymer electrolyte (SPE) fuel cell. A SPE fuel cell typically employs a cation exchange polymer membrane that serves as a physical separator between the anode and cathode while also serving as an electrolyte. In fuel cells, the solid polymer electrolyte membrane typically comprises a perfluorinated sulfonic acid polymer membrane in acid form. Such fuel cells are often referred to as proton exchange membrane or polymer electrolyte membrane (PEM) fuel cells. The membrane is disposed between and in contact with the anode and the cathode. Electrocatalysts in the anode and the cathode typically induce the desired electrochemical reactions and may comprise, for example, a metal black, an alloy and/or a metal catalyst supported on a substrate, e.g., platinum on carbon. SPE fuel cells typically also comprise porous, electrically conductive sheet materials that are in electrical contact with the electrodes, and which permit diffusion of the reactants to the electrodes. The conductive sheet materials may comprise, for example, a porous, conductive sheet material such as carbon fiber paper or carbon cloth. An assembly comprising a membrane, anode and cathode, and diffusion layers for each electrode, is sometimes referred to as a membrane electrode assembly (MEA). Bipolar plates, made of a conductive material and providing flow fields for the reactants, are placed between a number of adjacent MEA's. A number of MEA's and bipolar plates are assembled in this manner to provide a fuel cell stack.

In some MEA's the anode and cathode are formed directly on the membrane through a coating process. A variety of techniques have been developed for manufacturing catalyst coated membranes (CCM's) that apply an electrocatalyst coating solution directly to a membrane. However, the known methods are difficult to employ in high volume manufacturing operations. Known coating techniques such as painting, patch coating and screen printing are typically slow, can cause loss of valuable catalyst and require the application of relatively thick coatings. In addition, known techniques for spraying experience various problems, including, but not limited to, sagging, slumping, drooping, swelling, and other problems associated with excess “wetness” of the membrane. Swelling in particular causes serious problems, and a number of patents have been granted that address this issue. For example, U.S. Pat. No. 6,074,692 to Hulett, issued on Jun. 13, 2000 (the '692 patent), describes a method whereby the membrane is pre-swollen by contact with a liquid vehicle (for carrying the catalyst particles) before the electrode forming slurry is applied to the membrane electrolyte. The method described in the '692 patent prevents shrinking by constraining the now swollen membrane in the “x” and “y” directions during drying. In U.S. Pat. No. 6,967,038 to O'Brien, issued on Nov. 22, 2005 (the '038 patent), the issue of swelling is addressed by raised relief printing the catalyst coating composition comprising an electrocatalyst and an ion exchange polymer in a liquid medium onto a first surface of an ion exchange membrane. The raised relief printing according to the '038 patent forms at least one electrode layer covering at least a part of said surface of said membrane. According to the '038 patent, a preferred technique for raised relief printing technique is flexographic printing.

U.S. patent application Ser. No. 11/534,561, filed Sep. 22, 2006, entitled “Processes, Framed Membranes and Masks for forming Catalyst Coated Membranes and Membrane Electrode Assemblies,” the entirety of which is incorporated herein by reference, discloses particularly desirable processes for forming catalyst coated membranes, wherein cathode and anode layers are formed by spraying catalyst-containing inks onto a novel framed electrolytic membrane to form a catalyst coated membrane. The processes optionally employ one or more masks, which carefully control where the catalyst-containing ink is deposited.

While the above-described processes for forming catalyst coated membranes are satisfactory in many respects, the need remains for improved processes for forming catalyst coated membranes. In particular, the need exists for high volume processes for forming catalyst coated membranes.

Additionally, the need exists for improved sprayable inks that are suitable in spray processes for forming catalyst coated membranes. For example, the need exists for sprayable inks having a high concentration of catalyst particles, and which have a long shelf life with little or no settling of catalyst particles.

### SUMMARY OF THE INVENTION

The present invention is directed to inks and processes for forming catalyst coated membranes for use in fuel cells, and more preferably for use in methanol fuel cells.

In a first embodiment, the invention is to a sprayable ink, comprising catalyst particles; polymer electrolyte ionomer; and a vehicle dispersing the catalyst particles and the polymer electrolyte ionomer, wherein the catalyst particles have a d50 that does not increase by more than 10%, measured 24 hours after high shear mixing.

In another embodiment, the invention is to a process for forming a catalyst coated membrane, comprising the steps of (a) depositing, e.g., spraying, an ink comprising catalyst particles and a vehicle (and preferably a polymer electrolyte ionomer) onto a membrane (e.g., a heated membrane); and (b) vaporizing from 40 to 90 weight percent of the vehicle from the sprayed ink under conditions effective to form a catalyst layer on the membrane; wherein steps (a) and (b) are alternated, e.g., at least five times, to form multiple stacked catalyst layers on the membrane. Preferably, the catalyst particles have a d50 that does not increase by more than 10%, measured 24 hours after high shear mixing. The vaporizing optionally is facilitated by heating the membrane. The membrane preferably comprises a polymer electrolyte membrane. In various other embodiments, the invention is to a catalyst coated membrane formed by this process or a membrane electrode assembly comprising the catalyst coated membrane.

In the process of the present invention, in a preferred aspect, the process further comprises controlling catalyst layer porosity by controlling the temperature of the membrane. For example, the process optionally further comprises the step of controlling porosity in the multiple stacked catalyst layers by controlling the amount of vehicle vaporized in each alternating vaporizing step. Optionally, the amount of vehicle vaporized in each alternating vaporizing step optionally increases so as to create a porosity gradient in a direction perpendicular to a surface of the membrane. In this aspect, the amount of vehicle vaporized in each alternating vaporizing step optionally decreases so as to create a porosity gradient in a direction perpendicular to a surface of the membrane. The spraying preferably comprises aerosolizing the ink into a plurality of catalyst-containing droplets, the droplets having an average droplet size of from about 20 to about 60 microns. Preferably, multiple stacked catalyst layers are formed on the membrane through alternating spraying and vaporizing steps, the multiple layers being formed from multiple inks, at least two of the multiple inks, respectively, comprising catalyst particles having different average particle sizes from one another. In another aspect, multiple stacked catalyst layers are formed on the membrane through alternating spraying and vaporizing steps, the multiple layers being formed from multiple inks, at least two of the multiple inks, respectively, comprising compositionally different catalyst particles from one another. In one aspect, the process is repeated, optionally with a second ink, for the other side of the membrane.

In one aspect, the spraying step comprises: (i) spraying a first portion of the membrane with a first ink mixture comprising the liquid vehicle, a first catalyst amount of catalyst particles, and a first polymer electrolyte ionomer amount of polymer electolyte ionomer; and (ii) spraying a second portion of the membrane with a second ink mixture comprising the liquid vehicle, a second catalyst amount of catalyst particles, and a second polymer electrolyte ionomer amount of polymer electolyte ionomer, under conditions effective to form a catalyst gradient and/or polymer electrolyte ionomer gradient on the membrane. The gradient may be a horizontal gradient and/or a vertical gradient. For example, the process optionally forms a catalyst layer having a vertical and/or a horizontal gradient, e.g., porosity gradient, particle size gradient, and/or catalyst particle concentration gradient.

Optionally, the ink has a total solids loading of from about 5 to about 20 weight percent. The weight ratio of the catalyst particles to the polymer electolyte ionomer is optionally greater than about 5:1. At least a majority of the catalyst particles optionally have a spherical morphology. The catalyst particles optionally have an average particle size of from about 1 to about 10 microns, or, in another embodiment, from about 200 to about 1000 nanometers. The catalyst particles optionally comprise metal crystallites having an average crystallite size of less than about 10 nm. The catalyst particles optionally comprise a mixture of at least two different types of catalyst particles. Optionally, the catalyst particles comprise at least one of an elemental metal or an alloy. The catalyst particles optionally comprise supported catalyst particles. The catalyst particles, in one embodiment, comprise platinum. In some aspects, the catalyst particles comprise an alloy of platinum and ruthenium.

The ink preferably comprises the polymer electrolyte ionomer in an amount ranging from about 0.5 to about 5 weight percent. The weight ratio of the catalyst particles to the polymer electolyte ionomer in the ink optionally is from about 2 to about 10. The polymer electrolyte ionomer may, for example, comprise a sulfonated tetrafluorethylene copolymer.

The vehicle may vary widely, but in various optional embodiments is selected from the group consisting of: water, methanol, ethanol, propanol, 1-propanol, 2-propanol, glycols, ethylene glycols, propylene glycol, and combinations thereof. The vehicle optionally comprises water in an amount greater than about 60 wt. %. In one embodiment, the vehicle consists essentially of water. The ink optionally has a viscosity not greater than about 25 cP.

In another embodiment, the invention is to a process for forming a catalyst coated membrane having a desired catalyst layer porosity, comprising (a) providing a correlation between catalyst layer porosity and membrane temperature; (b) employing the correlation to determine a target membrane temperature based on the desired catalyst layer porosity; (c) heating a membrane to the target membrane temperature; and (d) depositing, e.g., spraying, an ink comprising catalyst particles and a vehicle onto the heated membrane, wherein heated membrane vaporizes the vehicle and forms a catalyst layer having the desired catalyst layer porosity. Preferably, the catalyst particles in the ink have a d50 that does not increase by more than 10%, measured 24 hours after high shear mixing. Step (d) optionally is repeated in several passes to form multiple stacked catalyst layers.

In another embodiment, the invention is to a catalyst coated membrane comprising a polymer electrolyte membrane having a first surface and a first catalyst layer disposed thereon, wherein the first catalyst layer has a porosity gradient in which porosity increases in a direction extending away from the first surface. The polymer electrolyte membrane optionally further comprises a second surface, and the catalyst coated membrane further comprises a second catalyst layer disposed on the second surface. Optionally, the first catalyst layer comprises polymer electolyte ionomer and catalyst particles, as described above.

### BRIEF DESCRIPTION OF THE DRAWINGS

The novel features and advantages of the present invention will best be understood by reference to the detailed description of the preferred embodiments which follows, when read in conjunction with the accompanying drawings, in which:

FIG. 1 is a simplified block diagram of a direct methanol fuel cell (DMFC) according to an embodiment of the present invention;

FIGS. 2a to 2e illustrate the structure of aggregate electrocatalyst particles that are useful in the inks of the present invention;

FIG. 3 illustrates a pattern for spraying one or more catalyst inks on a membrane for use in forming a membrane electrode assembly according to an embodiment of the present invention;

FIGS. 4A-4E illustrate spraying of sprayable catalyst ink, e.g., anode or cathode ink, on a membrane using a spraying nozzle according to an embodiment of the present invention;

FIG. 5 illustrates a carbon-supported catalyst droplet subsequent to spraying according to known methods;

FIG. 6 illustrates a cross-sectional view of a portion of an MEA according to an embodiment of the present invention comprising a vertical gradient in particle size within the catalyst layer;

FIG. 7 illustrates a system for spraying a catalyst ink onto a membrane according to an embodiment of the present invention;

FIG. 8 illustrates a cross-sectional view of a portion of an MEA according to an embodiment of the present invention comprising a horizontal gradient in particle size within the catalyst layer;

FIG. 9 illustrates an exploded view of a portion of an MEA according to an embodiment of the present invention comprising gradients in concentration with the catalyst layer;

FIG. 10 illustrates a cross-sectional view of a portion of an MEA according to an embodiment of the present invention comprising a vertical gradient in concentration within the catalyst layer;

FIG. 11 illustrates a cross-sectional view of a portion of an MEA according to an embodiment of the present invention comprising a horizontal gradient in concentration within the catalyst layer;

FIGS. 12a-12b illustrate a cross-sectional view of two methods of fabricating MEA structures with varying gradients in concentration in the vertical direction according to an embodiment of the present invention;

FIGS. 13a-13b illustrate a cross-sectional view of two methods of fabricating MEA structures with horizontal gradients in concentration according to an embodiment of the present invention;

FIGS. 14a-14b illustrate a cross-sectional view of two methods of fabricating MEA structures with horizontal and vertical gradients in concentration according to an embodiment of the present invention; and

FIG. 15 illustrates a cross-sectional view of MEA layers manufactured in accordance with an embodiment of the present invention using multiple spray nozzles.

### DETAILED DESCRIPTION OF THE INVENTION

The various features of the preferred embodiment(s) will now be described with reference to the drawing figures, in which like parts are identified with the same reference characters. The following description of the presently contemplated preferred embodiments of practicing the invention are not to be taken in a limiting sense, but are provided merely for the purpose of describing the general principles of the invention.

### I. Introduction

The present invention is directed to catalyst coated membranes (CCM's) and to inks and spray processes for manufacturing CCM's and membrane electrode assemblies (MEA's). MEA's are used in fuel cells, and more preferably, in direct methanol fuel cells (DMFC's). An MEA comprises a CCM disposed between two diffusion layers. A CCM comprises an electrolytic membrane, in a preferred embodiment, a sulfonated tetrafluoroethylene copolymer such as NAFION® (E. I. duPont de Nemours, Wilmington, Del.), having opposing major planar surfaces, an anode catalyst layer disposed on a first major planar surface, and a cathode catalyst layer disposed on a second major planar surface (catalyst layers may be applied in either order). According to several aspects of the present invention, the catalyst layers are formed on the major planar surfaces of the electrolytic membrane, preferably through a spraying process. The catalyst layers are preferably substantially porous and electrically conductive. The diffusion layers also preferably are electrically conductive and allow for the flow of reactants toward the catalyst layers and the removal of reaction products away from the catalyst layers.

Direct Methanol Fuel Cells

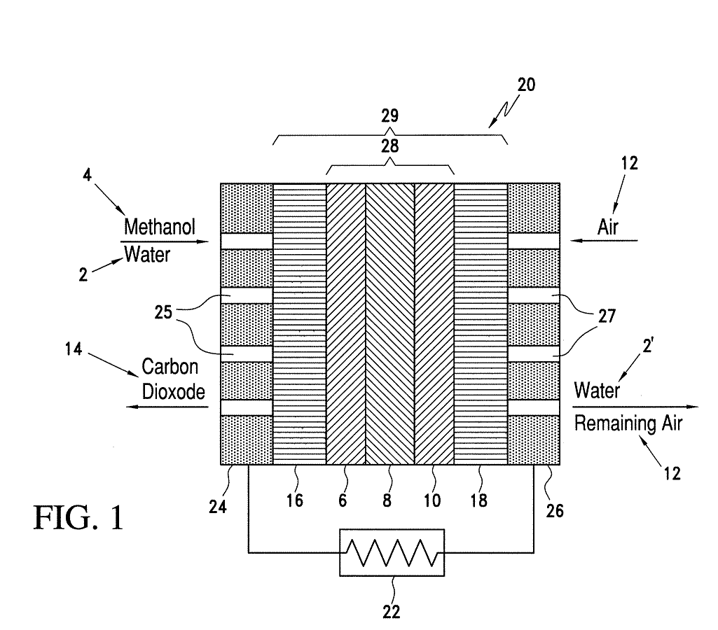

To appreciate the utility of the present invention, it is important to understand the structure and functionality of a DMFC. FIG. 1 is a simplified diagram of a DMFC 2 (not to scale) that comprises an MEA 29. MEA 29 comprises a CCM 28 and two diffusion layers 16, 18 disposed on the opposite sides thereof, respectively. Bipolar plates 24 and 26 are disposed between the anode and cathode of sequential MEA stacks and comprise current collectors and flow fields, 25 and 27, for directing the flow of incoming reactant fluid to the appropriate electrode. Two end plates (not shown), similar to the bipolar plates, are used to complete the fuel cell stack.

CCM 28 comprises an electrolytic membrane 8 (e.g., PEM membrane) having opposing major planar surfaces and catalyst layers disposed on each of the opposing major planar surfaces, respectively, and which may be formed, for example, from one or more sprayable catalyst-containing inks according to an embodiment of the present invention. Specifically, a first catalyst layer (anode 6) is formed, e.g., through spraying of a first catalyst-containing ink, on a first major planar surface of the electrolytic membrane 8, and a second catalyst layer (cathode 10) is formed, e.g., through spraying of a second catalyst-containing ink, on a second major planar surface of the electrolytic membrane 8.

As shown in FIG. 1, during operation, a fuel comprising methanol 4 in solution with water 2 is fed to the anode 6 side of the MEA. The solution of methanol 4 and water 2 is applied to anode 6 through bipolar plate 24 and liquid diffusion layer (LDL) 16, which is designed to spread methanol 4 across anode 6 as evenly and completely as possible. As the methanol 4 is oxidized at anode 6, carbon dioxide 14 is formed, which is efficiently and effectively channeled through LDL 16 and bipolar plate 24 and liberated to the environment. Protons, which are also formed in the oxidation reaction, are then transported (typically as hydronium ions) through the electrolytic membrane 8 to cathode 10, where the previously stripped electrons, having completed the path through external load/circuit 22, rejoin and react with oxygen from air 12, to form water 2′, which is then carried away from the fuel cell with any remaining air via gas diffusion layer (GDL) 18 and bipolar plate 26. GDL 18 is designed to efficiently and effectively channel water away (as water vapor) that forms at cathode 10, along with any remaining air 12. DMFCs and their operation are further described in pending U.S. patent application Ser. No. 10/417,417, filed Apr. 16, 2003 (Publ. No. US 2004/0038808 A1), the entirety of which is incorporated herein by reference.

As indicated above, the invention focuses on CCMs and inks and processes for manufacturing CCMs and MEAs. More specifically, the inks and processes are particularly suitable for forming CCMs and MEAs having desirable physical properties, e.g., porosity, for maximizing contact between the fuel cell reactant, e.g., methanol, the catalyst particles, and the PEM at the so-called “3-phase interface.” The 3-phase interface is where the electrocatalyst is in electrical contact with the electron conducting portions of the diffusion layer/bipolar plate, as appropriate, and diffusional contact with the PEM and the appropriate electrode fluid, i.e., methanol, hydrogen or oxygen. The present invention ideally maximizes the concentration of the three-phase interfaces within an MEA and thereby improves fuel cell efficiency.

### II. Inks

In one embodiment, the invention is to a sprayable ink comprising catalyst particles, polymer electrolyte ionomer (PEI), and a vehicle for dispersing the catalyst particles and PEI. The catalyst particles preferably have a d50 that does not increase by more than 10%, measured 24 hours after high shear mixing. In various embodiments, the ink optionally comprises, in addition to these components, one or more of the following: hydrophobic materials (HPOs), electrically conductive materials (ELCs), molecular metal precursors, and/or one or more additives.

Catalyst Particles

The specific types and properties of the catalyst particles included in the inks of the present invention may vary widely. Preferably, the catalyst particles comprise electrocatalyst particles. As used herein, the term catalyst particles or powders means at least one of three types: (1) unsupported catalyst particles, such as platinum black; (2) supported catalysts, such as aggregate particles; or (3) nanoparticles. Combinations of the foregoing electrocatalyst types can also be used. Unsupported catalyst particles are catalyst particles that are not supported on the surface of another material. These include such materials as platinum black and platinum/ruthenium black. In a preferred aspect, the catalyst particles comprise an alloy of platinum and ruthenium, optionally supported on a support phase, e.g., carbon black. Supported catalysts include an active species phase that is dispersed on a support phase. In one embodiment, the catalyst particles comprise one or more highly dispersed active species phases, typically metal or metal oxide clusters or crystallites, with dimensions on the order of about 1 nanometers to 10 nanometers that are dispersed over the surface of larger support particles. The support particles can be aggregated to form larger aggregate particles. For example, the support particles can be chosen from a metal oxide (e.g., RuO₂, In₂O₃, ZnO, IrO₂, SiO₂, Al₂O₃, CeO₂, TiO₂ or SnO₂), aerogels, xerogels, carbon or a combination of the foregoing. In the following discussion, carbon is used as an example. According to one embodiment, the carbon particles supporting the dispersed active species phase do not exist as individual particles but tend to associate to form structures that contain a number of individual particles that are aggregated.

The catalyst particles useful in the ink compositions of the present invention may be of virtually any size so long as the ink composition retains the requisite viscosity, surface tension and solids loading characteristics to enable it to be deposited using a spray device. The size and particle size distribution of particles for purposes of the present specification may be determined using laser scattering equipment (e.g., Microtrac, Inc. of Montgomeryville, Pa.) for particles larger than 500 nm in size, or by TEM for particles smaller than 500 nm in size, or by a combination thereof for particle populations that comprise some particles that are greater than 500 nm in size and other particles that are less than 500 nm in size.

Typical spray nozzles have channels on the order of 200 to 1000 μm in diameter or less and the particulates in the ink compositions are preferably an order of magnitude less than the channel diameter. To deposit the ink compositions using a spray device, the d90 particle size is preferably less than 10 μm, more preferably is less than 5 μm and most preferably is less than 3 μm. Therefore, to achieve particle size reduction and/or de-agglomeration of the particles, milling or other suitable techniques may be necessary. One method to decrease the particle size of the original electrocatalyst powder is to mill the powder, such as by wet-milling the powder.

In a first embodiment, the ink comprises micron-sized catalyst particles, for example, catalyst particles having an average particle size (mass median diameter (MMD)) of from about 1 to about 10 μm, e.g., from about 2 to about 8 μm or from about 4 to about 6 μm. Micron-size particles have an average particle size of greater than about 0.1 μm. In an alternative embodiment, the ink comprises smaller catalyst particles, e.g., catalyst particles having an average particle size of from about 200 to about 1000 nm, e.g., from about 200 to about 800 nm or from about 400 to about 600 nm. If the catalyst particles comprise supported catalyst particles, these ranges refer to the size of the catalyst particles including support particles.

The ink optionally comprises nanoparticles, e.g., metal crystallites (preferably disposed on larger support particles), which are particles having an average size of not greater than about 200 nanometers, e.g., not great than about 100 nm, not greater than about 75 nm, not greater than about 50 nm or from about 1 to about 50 nanometers. In one embodiment, the nanoparticles have an average size of from about 10 to 80 nanometers and preferably from about 25 to 75 nanometers. In one embodiment, the nanoparticles have an average size of from about 2 to 20 nanometers.

The nanoparticles and micron-sized particles are preferably spherical, such as those produced by spray processing, e.g., spray pyrolysis. Thus, at least a majority of the catalyst particles (more preferably at least about 60 weight percent, at least about 75 weight percent, at least about 90 weight percent or at least about 95 weight percent of the catalyst particles) in the ink preferably have a spherical morphology. The inks of the present invention optionally are substantially free of particles in the form of flakes or particles having a branched structure. Optionally, the catalyst particles are comprised of less than about 25 weight percent of particles having a flake or branched form, e.g., less than about 15 wt. %, less than about 10 wt. %, less than about 5 wt. %, less than about 1 wt %, less than about 0.5 wt % or less than about 0.25 wt %. In other embodiments, the ink may comprise particles in the form of flakes or particles having a branched structure. Inks comprising such flaked or branched particles may be amenable to spray deposition if the particles are sufficiently small in size, e.g., have an aggregate particle size of less than about 200 nm.

The catalyst particles, e.g., nanoparticles and/or micron-sized particles, may be supported or unsupported. The catalyst nanoparticles and/or catalyst micron-sized particles may comprise metals, metal oxides, metal carbides, metal nitrides or any other material that exhibits catalytic activity. The catalyst particles preferably have surfaces that are capped or otherwise protected to minimize nanoparticle agglomeration. The particles are preferably stabilized from aggregation by the adsorption of stabilizing polymer molecules on the particle surfaces. The stabilizing polymer can be selected from the group consisting of polyvinyl pyrollidone (PVP), PVDF, PBI or NAFION.

Throughout the present specification, with respect to supported catalysts, the larger structures formed from the association of discrete carbon particles supporting the dispersed active species phase are referred to as aggregates or aggregate particles, and typically have a size in the range from 0.3 to 100 μm. In various optional embodiments, the catalyst particles comprise catalyst aggregates having an average size of from about 0.5 μm to about 20 μm, e.g., from about 0.7 μm to about 15 μm or from about 1 μm to about 10 μm. In addition, the aggregates can further associate into larger “agglomerates”. The aggregate morphology, aggregate size, size distribution and surface area of the electrocatalyst powders are characteristics that have a critical impact on the performance of the catalyst.

The aggregate structure may include smaller primary particles, such as carbon or metal oxide primary particles, constituting the support phase. Two or more types of primary particles can be mixed to form the support phase. For example, two or more types of particulate carbon (e.g., amorphous and graphitic carbon) can be combined to form the support phase. The two types of particulate carbon can have different performance characteristics in a selected application and the combination of the two types in the aggregate structure can enhance the performance of the catalyst.

Among the forms of carbon available for the support phase, graphitic carbon is preferred for long-term operational stability of fuel cells. Amorphous carbon is preferred when a smaller crystallite size is desired for the supported active species phase. The carbon support particles typically have sizes in the range of about 10 nanometers to 5 μm, depending on the nature of the carbon material. However, carbon particulates having sizes up to 25 μm can be used as well.

The compositions and ratios of the aggregate particle components can be varied independently and various combinations of carbons, metals, metal alloys, metal oxides, mixed metal oxides, organometallic compounds and their partial pyrolysis products can be used. The catalyst particles can include two or more different materials as the dispersed active species. As an example, combinations of Ag and MnOₓ dispersed on carbon can be useful for some electrocatalytic applications. Other examples of multiple active species are mixtures of metal porphyrins, partially decomposed metal porphyrins, Co and CoO. Although carbon is a preferred material for the support phase, other materials such as metal oxides can also be useful for some electrocatalytic applications.

The supported catalyst particles preferably include a carbon support phase with at least about 1 weight percent active species phase, more preferably at least about 5 weight percent active species phase and even more preferably at least about 10 weight percent active species phase. In one embodiment, the particles include from about 20 to about 80 weight percent of the active species phase dispersed on the support phase. It has been found that such compositional levels give rise to the most advantageous electrocatalyst properties for many applications. However, the preferred level of the active species supported on the carbon support will depend upon the total surface area of the carbon, the type of active species phase and the application of the electrocatalyst. A carbon support having a low surface area will require a lower percentage of active species on its surface to achieve a similar surface concentration of the active species compared to a support with higher surface area and higher active species loading.

Metal-carbon catalyst particles include a catalytically active species of at least a first metal phase dispersed on a carbon support phase. The metal active species phase can include any metal and the particularly preferred metal will depend upon the application of the powder. The metal phase can be a metal alloy wherein a first metal is alloyed with one or more alloying elements. Thus, the catalyst particles included in the ink optionally comprise at least one of an elemental metal or an alloy. As used herein, the term metal alloy also includes intermetallic compounds between two or more metals. For example, the term platinum metal phase refers to a platinum alloy or platinum-containing intermetallic compound, as well as pure platinum metal. The metal-carbon electrocatalyst powders can also include two or more metals dispersed on the support phase as separate active species phases. Alloy catalyst particles suitable for use in the inks and processes of the present invention are disclosed, for example, in commonly owned U.S. patent application Ser. No. 11/328,147, filed Jan. 10, 2006, the entirety of which is incorporated by reference herein.

Preferred metals for the supported electrocatalytically active species include the platinum group metals and noble metals, particularly Pt, Ag, Pd, Ru, Os and their alloys. The metal phase can also include a metal selected from the group Ni, Rh, Ir, Co, Cr, Mo, W, V, Nb, Al, Ta, Ti, Zr, Hf, Zn, Fe, Cu, Ga, In, Si, Ge, Sn, Y, La, lanthanide metals and combinations or alloys of these metals. Preferred metal alloys include alloys of Pt with other metals, such as Ru, Os, Cr, Ni, Mn and Co. Particularly preferred among these is PtRu for use in the DMFC anode and PtCrCo or PtNiCo for use in the cathode. Alternatively, metal oxide-carbon catalyst particles that include a metal oxide active species dispersed on a carbon support phase may be used. The metal oxide can be selected from the oxides of the transition metals, preferably those existing in oxides of variable oxidation states, and most preferably from those having an oxygen deficiency in their crystalline structure. For example, the metal oxide active species can be an oxide of a metal selected from the group consisting of Au, Ag, Pt, Pd, Ni, Co, Rh, Ru, Fe, Mn, Cr, Mo, Re, W, Ta, Nb, V, Hf, Zr, Ti or Al. A particularly preferred metal oxide active species is manganese oxide (MnOₓ, where x is 1 to 2). The supported active species can include a mixture of different oxides, solid solutions of two or more different metal oxides or double oxides. The metal oxides can be stoichiometric or non-stoichiometric and can be mixtures of oxides of one metal having different oxidation states. The metal oxides can also be amorphous.

It is preferred that the average size of the active species is such that the catalyst particles include small single crystals or crystallite clusters, collectively referred to herein as clusters, of the active species dispersed on the support phase. Preferably, the average active species cluster size (diameter) is not greater than about 10 nanometers, more preferably is not greater than about 5 nanometers and even more preferably is not greater than about 3 nanometers. Preferably, the average cluster size of the active species is from about 0.5 to 5 nanometers. Preferably, at least about 50 percent by number, more preferably at least about 60 percent by number and even more preferably at least about 70 percent by number of the active species phase clusters have a size of not greater than about 3 nanometers. Electrocatalyst powders having a dispersed active species phase with such small crystallite clusters advantageously have enhanced catalytic properties as compared to powders including an active species phase having larger clusters.

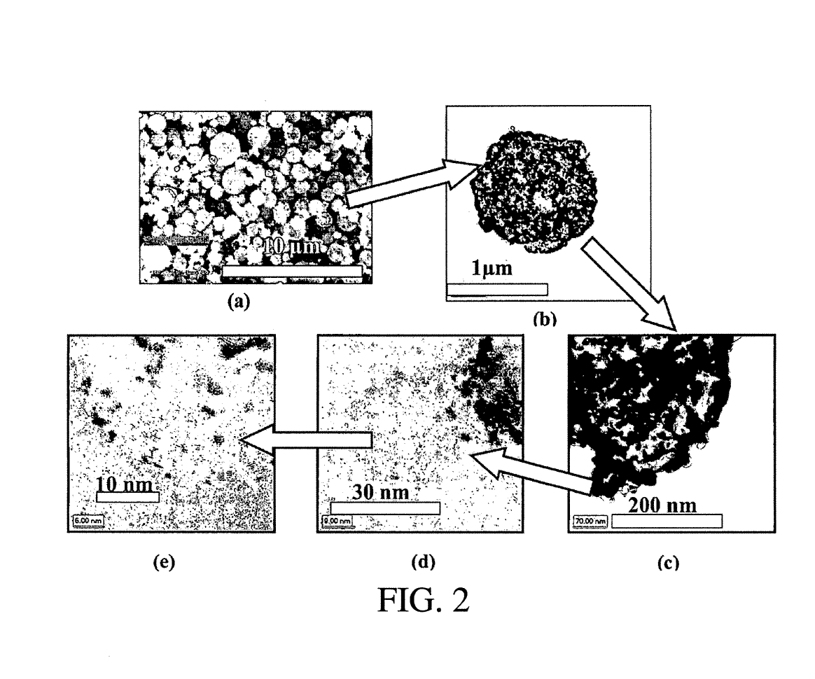

FIG. 2 illustrates the morphology and structure of an exemplary aggregate electrocatalyst powder according to an embodiment of the present invention. FIG. 2(a) illustrates a plurality of the aggregate catalyst particles in a powder batch. FIG. 2(b) illustrates one electrocatalyst particle having a size of about 1.2 μm. FIG. 2(c) illustrates the structure of the particle of FIG. 2(b) in greater detail, wherein the individual support particles can be seen. FIGS. 2(d) and 2(e) illustrate the active species dispersed on the support phase of the aggregate particle. Thus, the preferred electrocatalyst powders are not mere physical admixtures of different particles, but are comprised of support phase particles that include a dispersed phase of an active species.

Preferably, the composition of the aggregate catalyst particles is homogeneous. That is, the different phases of the electrocatalyst are well dispersed within a single aggregate particle. It is also possible to intentionally provide compositional gradients within the individual electrocatalyst aggregate particles. For example, the concentration of the dispersed active species phase in a composite particle can be higher or lower at the surface of the secondary support phase than near the center and gradients corresponding to compositional changes of 10 to 100 weight percent can be obtained. When the aggregate particles are deposited by a spray device, as discussed below, the aggregate particles preferably retain their structural morphology and therefore the functionality of the compositional gradient can be exploited in the device.

The catalyst particles should have certain physical attributes to be useful in ink compositions for spray devices, discussed below. These physical attributes can include density, porosity, settling velocity and spherical morphology.

The particles should remain well-dispersed in the ink composition for extended periods of time such that the reservoir into which the suspension is placed will have a long shelf-life. In some instances, substantially fully dense particles can be adequately dispersed and suspended. Depending upon the density of the particle compound, however, particles with a high density relative to the liquid in which they are dispersed and with a size in excess of about 0.5 μm cannot be suspended in a liquid that has a sufficiently low viscosity to be deposited using a spray device. In most cases, the apparent density of the particles must therefore be substantially lower than the theoretical density.

More specifically, it is desirable to maintain a substantially neutral buoyancy of the particles in the suspension while maintaining a relatively large physical size. The buoyancy is required for ink stability while the larger size maintains ink properties, such as viscosity, within useful ranges. Stated another way, it is desirable to provide particles having a low settling velocity (high shelf life) but with a sufficiently large particle size. The settling velocity of the particles is proportional to the apparent density of the particle (ρₛ) minus the density of the liquid (ρₗ). Ideally, the particles will have an apparent density that is approximately equal to the density of the liquid, which is typically about 1 g/cm³ (i.e., the density of water). It is preferable that the apparent density of such particles be a small percentage of the theoretical density. According to one embodiment, the particles have an apparent density that is not greater than about 50 percent of the theoretical density for the particle, more preferably not greater than about 20 percent of the theoretical density. Such particles would have small apparent sizes when measured by settling techniques, but larger sizes when measured by optical techniques.

Related to the density of the aggregates is the porosity of the aggregates. As noted above, lower aggregate densities allow easier suspension of the aggregates in an ink composition. Moreover, as is discussed below, porosity within certain layers of the MEA plays a critical role in the performance of the fuel cell. High porosity within the aggregate particles is advantageous for rapid transport of species into and out of the various structures of the MEA. It is preferred that the accessible (i.e., open) porosity in the aggregate catalyst particles is at least about 5 percent. More preferably, it is preferred that the open porosity is at least about 40 percent and even more preferably is at least about 60 percent.

It will be appreciated that varying particle morphologies can be utilized while maintaining an apparent density within the desired range. For example, the catalyst particles can have a sufficient porosity to yield a particle having an apparent density that is lower than the theoretical density. Open (surface) porosity can also decrease the apparent density if the surface tension of the liquid medium does not permit penetration of the surface pores by the liquid.

Thus, the particles according to the present invention preferably have a low settling velocity in a liquid medium. The settling velocity according to Stokes Law is defined as:

$$V = \frac{{D}_{st}^{2} ( {ρ}_{s} - {ρ}_{l} ) g}{18 η} \qquad ( 1 )$$

where:

D_{St}=Stokes diameter

η=fluid viscosity

ρₛ=apparent density of the particle

ρₗ=density of the liquid

V=settling velocity

g=acceleration due to gravity

Preferably, the average settling velocity of the particles is sufficiently low such that the suspensions have a useful shelf life without the necessity of frequent mixing. Thus, it is preferred that a large mass fraction of the particles, such as at least about 50 weight percent, remains suspended in the liquid. The particles preferably have an average settling velocity that is not greater than 50 percent and more preferably not greater than 20 percent of a theoretically dense particle of the same composition. Further, the particles preferably can be completely redispersed after settling, such as by mixing, to provide the same particle size distribution in suspension as measured before settling.

As indicated above, particularly for large batches of ink (e.g., greater than about 100 mL), the catalyst particles in the ink preferably have a d50 that does not increase by more than 10%, (e.g., by more than 8%, by more than 5%, by more than 3%, by more than 2%, or by more than 1%) measured 24 hours after high shear mixing. Further, 48 hours after high shear mixing, the d50 of the catalyst particles in the ink preferably has not increased by more than 10% (e.g., by more than 8%, by more than 5%, by more than 3%, by more than 2%, or by more than 1%). In one embodiment, the high shear mixing comprises mixing with an impeller (preferably in combination with a stator) at greater than 1000 rpm, e.g., greater than about 2000 rpm, greater than about 3000 rpm, greater than about 5000 rpm, or greater than about 8000 rpm. In terms of ranges, the mixing optionally occurs at a rate of from about 1000 rpm to about 10,000 rpm, e.g., from about 3000 to about 10000 rpm, or from about 5000 rpm to about 10000 rpm. See, e.g., U.S. Pat. Nos. 4,900,159; 5,570,955; 6,000,840; and 6,241,472, the entireties of which are incorporated herein by reference, for disclosures of various high shear mixers and processes for using same. In another embodiment, the high shear mixing comprises a microfluidization mixing process, e.g., with a Microfluidizer® of MicroFluidics Corp. See, e.g., U.S. Pat. No. 5,720,802, the entirety of which is incorporated herein by reference, which discloses a microfluidzation mixing process.

For small batches of ink, sonicating, e.g., horn sonicating, may be employed to provide an ink having a d50 that does not increase by more than 10% (e.g., by more than 8%, by more than 5%, by more than 3%, by more than 2%, or by more than 1%) measured 24 hours after the sonicating, e.g., horn sonicating. Sonicating, however, is generally less desirable than high shear mixing because it can result in localized overheating of the ink, and resultant poor ionomer distribution and loss of volatiles (e.g., vehicle). Moreover, sonication processes typically require enclosed vessels, which results in attendant ink volume limitations.

As shown in FIG. 2, the aggregate catalyst particles are preferably substantially spherical in shape. That is, the particles are preferably not jagged or irregular in shape. Spherical aggregate particles can advantageously be deposited using a variety of techniques, including deposition by a spray device, and can form layers that are thin and have a high packing density. In some cases, however, a low packing density is more preferable to achieve a highly porous feature.

In one embodiment, the catalyst particles comprise a mixture of at least two different types of catalyst particles. For example, the catalyst particles may have a multimodal (e.g., bimodal or trimodal) particle size distribution and comprise a first type of catalyst particle having a first average particle size and a second type of catalyst particle having a second average particle size. Catalyst particles having multimodal particle size distributions tend to exhibit greater packing than particles having a monomodal particle size distribution. In another aspect, the mixture comprises a first type of catalyst particle having a first catalyst loading of a first catalyst, and a second catalyst loading of a second catalyst. The first catalyst may be of a different type (e.g., different active species) than the second catalyst. Additionally or alternatively, the first catalyst loading may comprise a different catalyst concentration than the second catalyst loading.

In another embodiment, two or more inks are employed, each ink providing catalyst particles having a different average particle size. For example, in one embodiment, the multiple stacked catalyst layers are formed on a membrane, e.g., PEM, through alternating spraying and vaporizing steps, the multiple layers being formed from multiple inks, at least two of the multiple inks, respectively, comprising catalyst particles having different average particle sizes from one another.

In addition to the physical characteristics necessary to enable the particles to be useful in an ink composition, the catalyst particles preferably are also catalytically active and electrically conductive. Preferably, the anode catalyst particles catalyze the oxidization of hydrogen or methanol and are electrically conductive to enable the conduction of electrons out of the catalyst layer. Preferably, the cathode catalyst particles catalyze both the reduction of the oxygen and formation of water and are electrically conductive to enable the conduction of electrons into the catalyst layer.

The electrocatalyst powders preferably also have a well-controlled surface area. High surface area combined with high dispersion of the active species generally leads to increased catalytic activity in an energy device. Surface area is typically measured using the BET nitrogen adsorption method, which is indicative of the surface area of the powder including the internal surface area of accessible pores within the aggregate particles. Preferably, the catalyst particles have a surface area of at least about 10 m²/g, more preferably at least about 25 m²/g, more preferably at least about 90 m²/g and even more preferably at least about 600 m²/g, as measured by BET N₂ adsorption.

Preferably, the aggregate particles also retain the spherical morphology when incorporated into the fuel cell electrode (catalyst layer). It has been found that when a substantial fraction of the aggregate particles retain their spherical morphology in the catalyst layer, the device has improved electrocatalytic properties.

As is discussed below, the porosity of certain layers of the CCM will affect the transport characteristics of the MEA. Also, the formation of thin catalyst layers is advantageous for producing MEAs. A narrow aggregate particle size distribution is more likely to give a low packing density when the pores (spaces) between the aggregate particles have dimensions that are on the same length scale as the particles themselves. Therefore, in one embodiment, it is preferred that the electrocatalyst powders have a well-controlled average aggregate particle size to help tailor the porosity of such layers. Preferably, the volume average aggregate particle size (diameter) is not greater than about 100 μm, more preferably is not greater than about 20 μm and even more preferably is not greater than about 10 μm. Further, in one embodiment, it is preferred that the volume average aggregate particle size is at least about 0.3 μm, more preferably is at least about 0.5 μm and even more preferably is at least about 1 μm. As used herein, the average particle size is the median particle size (d₅₀). Powder batches having an average aggregate particle size satisfying the preferred parameters enable the formation of thin electrocatalytic layers and are capable of forming features having the desired packing density.

The particle size distributions of the aggregate particles, the support phase particles, and the supported active species are important in determining catalytic performance. Narrower aggregate particle size distributions may be preferred to allow deposition of the aggregate particles through a narrow orifice without clogging the spray nozzle of the spray device and to enable the formation of thin layers. For example, it is preferred that at least about 75 volume percent of the particles have a size of not greater than about two times the volume average particle size. As indicated above, the particle size distribution can also be bimodal or trimodal. A bimodal or trimodal particle size distribution can advantageously provide improved packing density and hence a denser aggregate particle layer structure in the MEA.

Catalyst particles and powders which have the foregoing properties and which are useful in accordance with the present invention are disclosed in commonly-owned U.S. patent application Ser. No. 09/815,380, which is incorporated herein by reference in its entirety.

Catalyst particles useful in accordance with the present invention are preferably manufactured using spray processing, spray conversion or spray pyrolysis, the methods, collectively referred to herein as spray processing. Spray processing methods are disclosed, for example, in the following commonly owned U.S. patent applications: Ser. No. 09/815,380, filed Mar. 22, 2001 (Publ. No. US 2002/0107140 A1); and Ser. No. 10/417,417, filed Apr. 16, 2003 (Publ. No. US 2004/0038808 A1), the entireties of which are incorporated by reference herein. See also U.S. patent applications Ser. No. 11/117,701, filed Apr. 29, 2005 (Publ. No. US 2006/0083694 A1); Ser4. No. 11/328,147, filed Jan. 10, 2006; and Ser. No. 11/335,729, filed Jan. 20, 2006, and Shah et al. (Langmiur, 1999, Vol. 15, pp. 1584-1587), the entireties of which are incorporated herein by reference.

Polymer Electolyte Ionomer

In addition to catalyst particles, the inks of the present invention preferably include polymer electrolyte ionomer (PEI). PEI's are materials which are capable of selectively transporting protons. In fuel cells, the PEI's facilitate the transport of protons to the PEM in the anode and to the active sites in the cathode. Preferred PEI's include polymers created from poly[perfluorosulfonic] acid, polysulfones, perfluorocarbonic acid, PBI, PVDF and styrene-divinylbenzene sulfonic acid. A particularly preferred PEI is a sulfonated tetrafluoroethylene copolymer such as NAFION, described above with respect to PEMs. The PEI can be comprised of any material, organic or inorganic, that has proton conducting properties including proton conducting metal oxides embedded in other materials such as organic polymers. The PEI preferably is incorporated into an ink composition according to the present invention directly incorporating the PEI within the ink composition, such as in the form of an emulsion or a solution.

The concentration of PEI contained in the ink of the present invention may vary widely depending, for example, on the desired proton conducting properties of the catalyst layer composition to be formed. Optionally, the ink comprises the PEI in an amount greater than about 0.25 weight percent, e.g., greater than about 0.5 weight percent, greater than about 1 weight percent, or greater than about 2 weight percent. In terms of upper range limits, optionally in combination with these lower limits, the ink comprises the PEI in an amount less than about 10 weight percent, e.g., less than about 8 weight percent, less than about 5 weight percent, or less than about 3 weight percent. Some preferred exemplary ranges include from about 0.25 to about 10 weight percent, from about 0.5 to about 5 weight percent or from about 1 to about 3 weight percent.

The ratio of catalyst particles to PEI may also be important, for example, in forming a catalyst layer having the desired balance between catalytic activity and proton conducting properties. In some exemplary preferred embodiments, the weight ratio of catalyst particles (including any support particles) to PEI in the ink is greater than about 2:1, e.g., greater than about 3:1, greater than about 4:1 or greater than about 5:1. Optionally, the weight ratio of catalyst particles to PEI in the ink is less than about 20:1, e.g., less than about 15:1, less than about 10:1 or less than about 7:1. Some exemplary preferred ranges are from about 2:1 to about 20:1, e.g., from about 2:1 to about 10:1, from about 4:1 to about 8:1, or from about 5:1 to about 6:1.

The PEI preferably has an average molecular weight of from about 900 to about 1300, e.g., from about 900 to about 1200, from about 900 to about 1100, from about 900 to about 1000, from about 1000 to about 1300, from about 1100 to about 1300, or from about 1200 to about 1300. Some preferred molecular weights include 980, 1100 and 1200.

Vehicle

The ink of the present invention also comprises a liquid vehicle. Preferably, the vehicle comprises one or more solvents capable of dispersing the catalyst particles throughout the ink. Additionally, the vehicle should be capable of stably dispersing the PEI contained in the ink.

A liquid vehicle is a flowable liquid medium that facilitates the deposition of the catalyst particles and the PEI onto a PEM. In cases where the liquid serves only to carry particles and not to dissolve any molecular species, the terminology of vehicle is often used for the liquid. However, in compositions including a molecular metal precursor, a solvent can also be considered the vehicle.

The vehicle employed in the inks of the present invention preferably imparts certain physical characteristics to the inks in order to render them suitable for spray applications. For example, the vehicle may impart physical characteristics that are controlled to within certain ranges, such as surface tension, viscosity and solids loading, to enable the ink composition to be deposited with a spraying device.

The liquid vehicle can also include carriers to hold particles (either or both the catalyst particles and/or the PEI) together once the ink composition is deposited, e.g., sprayed. Further, the liquid vehicle optionally includes a molecular species, e.g., a molecular metal precursor, that can react with or separately from the dispersed catalyst particles and/or PEI to modify the properties of the particles or form a separate metal phase in the ultimately formed catalyst layer.

Thus, the liquid vehicle may include a solvent capable of solubilizing a molecular metal precursor. The solvent can be water thereby forming an aqueous-based ink. Thus, in various embodiments, the vehicle optionally comprises, consists essentially of, or consists of water. In one embodiment, the ink comprises water in an amount greater than about 30 weight percent, greater than about 50 weight percent, greater than about 60 weight percent or greater than about 75 weight percent. Water is more environmentally acceptable than organic solvents. If water is employed in (or as) the vehicle, the weight ratio of the water to the catalyst particles contained in the ink preferably is from about 3:1 to about 10:1, e.g., from about 3:1 to about 7:1, or from about 3:1 to about 5:1, and most preferably about 4.2:1.

The liquid vehicle may be an organic solvent, by itself or in addition to water. If the ink comprises a molecular metal precursor, the selected solvent should be capable of solubilizing the selected molecular metal precursor to a high level. A low solubility of the molecular metal precursor in the solvent leads to low yields of the deposited material.

If the ink comprises a molecular metal precursor, the solubility of the molecular metal precursor in the solvent is preferably at least about 5 weight percent metal precursor, more preferably at least 30 weight percent metal precursor, even more preferably at least about 50 weight percent metal precursor and most preferably at least about 60 weight percent metal precursor. Such high levels of metal precursor lead to increased metal yield and the ability to deposit features having adequate thickness.

The vehicle, e.g., solvent, can be polar or non-polar. Vehicles useful in the ink composition of the present invention include amines, amides, alcohols, water, ketones, unsaturated hydrocarbons, saturated hydrocarbons, mineral acids organic acids and bases, Preferred vehicles include alcohols, amines, amides, water, ketone, ether, aldehydes and alkenes. Particularly preferred organic vehicles according to the present invention include N,N,-dimethylacetamide (DMAc), diethyleneglycol butylether (DEGBE), ethanolamine, ethylene glycol, acetone, and N-methyl pyrrolidone.

In some cases, the vehicle can be a high melting point vehicle, such as one having a melting point of at least about 30° C. and not greater than about 100° C. In this embodiment, a heated spray device such as a heated spray nozzle can be used to deposit the ink while in a flowable state whereby the vehicle solidifies upon contacting the substrate, e.g., PEM. Subsequent processing can then remove the vehicle by other means and then convert the material to the final product, thereby retaining resolution. Preferred vehicle according to this embodiment are waxes, high molecular weight fatty acids, alcohols, acetone, N-methyl-2-pyrrolidone, toluene, tetrahydrofuran and the like. Alternatively, the ink may be a liquid at room temperature, wherein the substrate, e.g., PEM, is kept at a lower temperature below the freezing point of the composition.

The vehicle can also be a low melting point vehicle. A low melting point is required when the ink must remain as a liquid on the substrate, e.g., PEM, until dried. A preferred low melting point vehicle according to this embodiment is DMAc, which has a melting point of about −20° C.

In addition, the vehicle can be a low vapor pressure vehicle. A lower vapor pressure advantageously prolongs the work life of the ink composition in cases where evaporation in the spray device, nozzle or other tool leads to problems such as clogging. A preferred vehicle according to this embodiment is terpineol. Other low vapor pressure vehicles include diethylene glycol, ethylene glycol, hexylene glycol, N-methyl-2-pyrrolidone, and tri(ethylene glycol) dimethyl ether.

The vehicle can also be a high vapor pressure vehicle, such as one having a vapor pressure of at least about 1 kPa. A high vapor pressure allows rapid removal of the vehicle by drying. High vapor pressure vehicles include acetone, tetrahydrofuran, toluene, xylene, ethanol, methanol, 2-butanone and water.

Examples of preferred vehicles are listed in Table 1. Particularly preferred vehicles for use with molecular metal precursors, if present in the ink, include alpha terpineol, toluene and ethylene glycol.

TABLE 1
Organic Vehicles Useful in Sprayable Inks

| Formula/Class | Name |
|---|---|
| Alcohols | 2-Octanol |
| | Benzyl alcohol |
| | 4-hydroxy-3methoxy benzaldehyde |
| | Isodeconol |
| | Butylcarbitol |
| Terpene alcohol | Alpha-terpineol |
| | Beta-terpineol |
| | Cineol |
| Esters | 2,2,4 trimethylpentanediol-1,3 |
| | monoisobutyrate |
| | Butyl carbitol acetate |
| | Butyl oxalate |
| | Dibutyl phthalate |
| | Dibutyl benzoate |
| | Butyl cellosolve acetate |
| | Ethylene glycol diacetate |
| | N-methyl-2-pyrrolidone |
| Amides | N,N-dimethyl formamide |
| | N,N-dimethyl acetamide |
| Aromatics | Xylenes, Aromasol |
| Substituted aromatics | Nitrobenzene |
| | o-nitrotoluene |
| Terpenes | Alpha-pinene, beta-pinene, dipentene, |
| | dipentene oxide |
| Essential Oils | Rosemary, lavender, fennel, sassafras, |
| | wintergreen, anise oils, camphor, |
| | turpentine |

In one preferred embodiment, the ink comprises a vehicle selected from the group consisting of: water, methanol, ethanol, propanol, 1-propanol, 2-propanol, glycols, ethylene glycols, propylene glycol, and combinations thereof. In a preferred exemplary combination, the vehicle comprises about 30 wt % water, about 30 wt % of an alcohol (e.g., methanol, ethanol, 1-propanol, 2-propanol or a combination thereof), and about 40 wt % glycol (e.g., ethylene glycol or propylene glycol). In another preferred combination, the vehicle comprises about 70 wt % water and about 30 wt. % of an alcohol (e.g., methanol, ethanol, 1-propanol, 2-propanol or a combination thereof).

Examples of additional liquid vehicles that may be suitable for the spray applications of the present invention are disclosed in U.S. Pat. No. 5,853,470. by Martin et al.; U.S. Pat. No. 5,679,724 by Sacripante et al.; U.S. Pat. No. 5,725,647 by Carlson et al.; U.S. Pat. No. 4,877,451 by Winnik et al.; U.S. Pat. No. 5,837,045 by Johnson et al.; and U.S. Pat. No. 5,837,041 by Bean et al. Each of the foregoing U.S. patents is incorporated by reference herein in its entirety.

Optional Additional Ink Components

Additionally, the ink compositions of the present invention may include other components, such as, for example, hydrophobic materials (HPOs), electrically conductive materials (ELCs), molecular metal precursors, reducing agents and/or one or more additives. HPOs are used to facilitate the transport of water and methanol to the active sites within the anode catalyst layers and away from the PEM to prevent cross-over. HPOs are also used in the cathode catalyst layer to facilitate the removal of water from the cathode. ELCs are used to facilitate the transport of electrons to the bipolar plate and catalyst layers in the cathode.

HPOs prevent certain hydrophilic liquids, such as water and methanol, from reaching or staying within certain areas of the MEA. The standard measure of hydrophobicity for a surface is the contact angle between that surface and a water droplet sitting on it, as determined by a contact goniometer. The angle is measured at the base of the water droplet. A surface is generally considered to be hydrophobic if the contact angle is greater than 90° and hydrophilic if the contact angle is less than 90°.

As is known by those skilled in the art, hydrophobic materials and hydrophilic materials are generally not miscible. As such, a greater amount of energy will be required to transport liquids within or through a hydrophobic material than through a neutral or hydrophilic material. Likewise, less energy is required to remove liquids from hydrophobic areas. In accordance with certain embodiments of the present invention, HPOs are deposited in select areas of the MEA to facilitate transfer of water or methanol to, from or out of certain areas within the MEA. Preferred HPOs include hydrophobic materials such as tetrafluoroethylene (TFE) fluorocarbon polymers, glass, nylon and polyethersulfones. A particularly preferred HPO is a TFE fluorocarbon polymer sold under the name TEFLON (E. I. duPont de Nemours, Wilmington, Del.). The function of the HPO is generally to manage the transport of water or other hydrophilic liquids by repelling them from certain areas within the layer. The HPO may be incorporated into an ink composition according to the present invention by using multi-component particles, for example incorporated into the catalyst particles or PEI, or by directly incorporating the HPO within the ink composition, such as in the form of an emulsion or a solution.

Preferred ELCs include electrically conductive carbon such as graphite carbon, acetylene black carbon or activated carbon. The desired properties of these carbon materials are that they be electronically conductive, resistant to corrosion under electrochemical load and that they be dispersable to yield an appropriate viscosity ink composition to be sprayed by the methods of the present invention.

According to one embodiment of the present invention, as mentioned above, the ink composition further comprises molecular metal precursors, e.g., low temperature molecular metal precursors, such as a molecular metal precursor that has a relatively low decomposition temperature. As used herein, the term molecular metal precursor refers to a molecular compound that includes a metal atom. Examples include organometallics (molecules with carbon-metal bonds), metal organics (molecules containing organic ligands with metal bonds to other types of elements such as oxygen, nitrogen or sulfur) and inorganic compounds such as metal nitrates, metal halides and other metal salts.

Particularly preferred molecular metal precursors for inclusion in the inks of the present invention include precursors to silver (Ag), nickel (Ni), platinum (Pt), ruthenium (Ru), cobalt (Co), iron (Fe), rhodium (Rh), gold (Au), palladium (Pd), copper (Cu), indium (In) and tin (Sn). Other molecular metal precursors can include precursors to aluminum (Al), zinc (Zn), iron (Fe), tungsten (W), molybdenum (Mo), lead (Pb), bismuth (Bi) and similar metals. The molecular metal precursors can be either soluble or insoluble in the ink composition.

In general, molecular metal precursor compounds that eliminate ligands by a radical mechanism upon conversion to metal are preferred, especially if the species formed are stable radicals and therefore lower the decomposition temperature of that precursor compound.

Furthermore, molecular metal precursors containing ligands that eliminate cleanly upon precursor conversion and escape completely from the substrate (or the formed functional structure) are preferred because they are not susceptible to carbon contamination or contamination by anionic species such as nitrates. Therefore, preferred precursors for metals used for conductors are carboxylates, alkoxides or combinations thereof that convert to metals, metal oxides or mixed metal oxides by eliminating small molecules such as carboxylic acid anhydrides, ethers or esters. Metal carboxylates, particularly halogenocarboxylates such as fluorocarboxylates, are particularly preferred metal precursors due to their high solubility.

Particularly preferred molecular metal precursor compounds are metal precursor compounds containing silver, nickel, platinum, gold, palladium, copper and ruthenium. In one preferred embodiment of the present invention, the molecular metal precursor compound comprises platinum.

Various molecular precursors can be used for platinum metal. Preferred molecular precursors for platinum include nitrates, carboxylates, beta-diketonates, and compounds containing metal-carbon bonds. Divalent platinum(II) complexes are particularly preferred. Preferred molecular precursors also include ammonium salts of platinates such as ammonium hexachloro platinate (NH₄)₂PtCl₆, and ammonium tetrachloro platinate (NH₄)₂PtCl₄; sodium and potassium salts of halogeno, pseudohalogeno or nitrito platinates such as potassium hexachloro platinate K₂PtCl₆, sodium tetrachloro platinate Na₂PtCl₄, potassium hexabromo platinate K₂PtBr₆, potassium tetranitrito platinate K₂Pt(NO₂)₄; dihydrogen salts of hydroxo or halogeno platinates such as hexachloro platinic acid H₂PtCl₆, hexabromo platinic acid H₂PtBr₆, dihydrogen hexahydroxo platinate H₂Pt(OH)₆; diammine and tetraammine platinum compounds such as diammine platinum chloride Pt(NH₃)₂Cl₂, tetraammine platinum chloride [Pt(NH₃)₄]Cl₂, tetraammine platinum hydroxide [Pt(NH₃)₄](OH)₂, tetraammine platinum nitrite [Pt(NH₃)₄](NO₂)₂, tetrammine platinum nitrate Pt(NH₃)₄(NO₃)₂, tetrammine platinum bicarbonate [Pt(NH₃)₄](HCO₃)₂, tetraammine platinum tetrachloroplatinate [Pt(NH₃)₄]PtCl₄; platinum diketonates such as platinum (II) 2,4-pentanedionate Pt(C₅H₇O₂)₂; platinum nitrates such as dihydrogen hexahydroxo platinate H₂Pt(OH)₆ acidified with nitric acid; other platinum salts such as Pt-sulfite and Pt-oxalate; and platinum salts comprising other N-donor ligands such as [Pt(CN)₆]⁴⁺.

Platinum precursors useful in organic-based ink compositions include Pt-carboxylates or mixed carboxylates. Examples of carboxylates include Pt-formate, Pt-acetate, Pt-propionate, Pt-benzoate, Pt-stearate, Pt-neodecanoate. Other precursors useful in organic ink composition include aminoorgano platinum compounds including Pt(diaminopropane)(ethyl-hexanoate). Preferred combinations of platinum precursors and solvents include: PtCl₄ in H₂O; Pt-nitrate solution from H₂Pt(OH)₆; H₂Pt(OH)₆ in H₂O; H₂PtCl₆ in H₂O; and [Pt(NH₃)₄](NO₃)₂ in H₂O.

The molecular metal precursor can form essentially the same component as the particles in the ink composition. In such a case, the particles in the liquid vehicle can advantageously catalyze the molecular precursor to form the desired compound. The addition of precursors with decomposition temperatures below about 300° C. allows the formation of functional features on a polymeric substrate, including polyamide, fluoro-polymers (e.g., a PEM), epoxy laminates and other substrates. This enables the liquid vehicle, a precursor to a metal and a polymer material, such as a PEI, HPO and precursors thereof, to be processed at low temperatures to form the desired structure. In one embodiment, the conversion temperature is not greater than about 250° C., such as not greater than about 225° C., more preferably is not greater than about 200° C., and even more preferably is not greater than about 185° C. In certain embodiments, the conversion temperature can be not greater than about 150° C., such as not greater than about 125° C. and even not greater than about 100° C. The conversion temperature is the temperature at which the metal species contained in the molecular metal precursor compound is at least 95 percent converted to the pure metal. As used herein, the conversion temperature is measured using a thermogravimetric analysis (TGA) technique wherein a 50-milligram sample of the ink is heated at a rate of 10° C./minute in air and the weight loss is measured.

If the ink comprises a molecular metal precursor, the ink optionally further comprises one or more reducing agents to lower the decomposition temperature of the precursors and/or prevent the undesirable oxidation of metal species. Reducing agents are materials that are oxidized, thereby causing the reduction of another substance. The reducing agent loses one or more electrons and is referred to as having been oxidized. Reducing agents are particularly applicable when using molecular metal precursor compounds where the ligand is not reducing by itself. Examples of reducing agents include amino alcohols. Alternatively, the precursor conversion process can take place under reducing atmosphere, such as hydrogen or forming gas.

In some cases, the addition of a reducing agent results in the formation of the metal even under ambient conditions. The reducing agent can be part of the molecular metal precursor itself, for example in the case of certain ligands. An example is Cu-formate where the precursor forms copper metal even in ambient air at low temperatures. In addition, the Cu-formate precursor is highly soluble in water, results in a relatively high metallic yield and forms only gaseous byproducts, which are reducing in nature and protect the in-situ formed copper from oxidation. Copper formate is therefore a preferred copper precursor for aqueous based inks. Other examples of molecular metal precursors containing a ligand that is a reducing agent are Ni-acetylacetonate and Ni-formate.

Also, if the ink comprises a molecular metal precursor, the ink optionally further comprises support particles, such as carbon particles, on which a metal active phase may be formed from the molecular metal precursor. In one aspect, the ink comprises the support particles in an amount from about 0.1 to about 5 weight percent.

In various embodiments, the ink of the present invention may also include one or more additives including, but not limited to, surfactants, dispersants, defoamers, chelating agents, humectants, crystallization inhibitors, adhesion promoters, complexing agents, rheology modifiers, and the like. Surfactants are also used to maintain the particles in suspension. Co-solvents, also known as humectants, are used to prevent the ink from crusting and clogging the orifice of the spray nozzle. Biocides can also be added to prevent bacterial growth over time. The selection of such additives is based upon the desired properties of the composition. Particles can be mixed with the liquid vehicle using a mill or, for example, an ultrasonic processor or by other means of mixing particulates, reagents and liquid known to those skilled in the art.

The ink compositions, particularly those incorporating molecular metal precursors, may also include crystallization inhibitors. A preferred crystallization inhibitor is lactic acid. Such inhibitors reduce the formation of large crystallites directly from the molecular metal precursor. Other crystallization inhibitors include ethylcellulose and polymers such as styrene allyl alcohol (SAA) and polyvinyl pyrrolidone (PVP). Other compounds useful for reducing crystallization are other polyalcohols such as malto dextrin, sodium carboxymethylcellulose and TRITON X100. In general, solvents with a higher melting point and lower vapor pressure inhibit crystallization of any given compound more than a lower melting point solvent with a higher vapor pressure. Preferably, not greater than about 10 weight percent crystallization inhibitor as a percentage of the total composition is added, preferably not greater than 5 weight percent and more preferably not greater than 2 weight percent.

The ink compositions can also include an adhesion promoter adapted to improve the adhesion of the layer to the underlying substrate (or underlying layers). For example, polyamic acid can improve the adhesion of the composition to a polymer substrate. In addition, the ink compositions can include rheology modifiers. As an example, styrene allyl alcohol (SAA) can be added to the ink composition to reduce spreading on the substrate.

The ink compositions, particularly those including molecular metal precursors, can also include complexing agents. Complexing agents are a molecule or species that binds to a metal atom and isolates the metal atom from solution. Complexing agents are adapted to increase the solubility of the molecular precursors, in the solvent, resulting in a higher yield of metal. One preferred complexing agent, particularly for use with Cu-formate and Ni-formate, is 3-amino-1-proponal. For example, a preferred ink for the formation of copper includes Cu-forrnate dissolved in water and 3-amino-1-propanol.

The ink compositions can also include rheology modifiers. Rheology modifiers can include SOLTHIX 250 (Avecia Limited), SOLSPERSE 21000 (Avecia Limited), styrene allyl alcohol (SAA), ethyl cellulose, carboxy methylcellulose, nitrocellulose, polyalkylene carbonates, ethyl nitrocellulose, and the like. These additives can reduce spreading of the ink after deposition.

Ink Properties

As indicated above, the vehicle employed in the ink of the present invention preferably imparts certain physical characteristics to the ink in order to render the ink suitable for spray applications. For example, the vehicle may impart physical characteristics that are controlled to within certain ranges, such as surface tension, viscosity and solids loading, to enable the ink composition to be deposited with a spraying device, e.g., through a spray nozzle.

Preferably, the surface tension of the ink is not greater than about 50 dynes/cm, such as not greater than about 30 dynes/cm, and in one embodiment is from about 20 to 25 dynes/cm. In one embodiment, the surface tension of the ink is from about 24 to about 34, or preferably about 29 dynes/cm.

The ink of the present invention preferably has a viscosity of not greater than about 1000 centipoise, more preferably not greater than about 100 centipoise and even more preferably not greater than about 50 centipoise. For use in spray devices, the viscosity of the ink composition is preferably not greater than about 100 centipoise, not greater than about 50 centipoise, not greater than about 30 centipoise, not greater than about 25 centipoise, or not greater than about 15 centipose. In terms of lower range limits, optionally in combination with these upper range limits, the ink optionally has a viscosity of not more than about 30 centipoise, not more than about 50 centipoise, or not more than about 75 centipoise. Some exemplary preferred ranges include viscosities ranging from about 5 to about 50 centipoise, from about 5 to about 30 centipoise, from about 5 to about 25 centipoise, or from about 8 to about 12 centipoise.

The total solids loading either in particulate or soluble form (including catalyst particles and polymer electolyte ionomer) in the ink composition can be as high as possible without adversely affecting the viscosity or other desirable properties of the ink. The ink composition can have a particle loading of up to about 75 weight percent, such as from about 5 to about 50 weight percent, e.g., from about 5 to about 30 weight percent or from about 5 to about 20 weight percent. The ink is preferably capable of being deposited, e.g., sprayed, on a PEM to form a catalyst coated membrane, as discussed below.

### III. Processes for Forming Catalyst Coated Membranes and Membrane Electrode Assemblies

Overview

As indicated above, in one embodiment, the present invention is to a process for forming a CCM or MEA, comprising the steps of depositing, preferably spraying, an ink comprising catalyst particles and a vehicle (and preferably PEI) onto a membrane (e.g., PEM), and vaporizing the vehicle from the deposited ink under conditions effective to form a catalyst layer on the membrane. In the process, the depositing and vaporizing steps are alternated to form multiple stacked catalyst layers on the membrane. Preferably, the vaporizing comprises vaporizing from 40 to 95 weight percent of the vehicle before a following layer is formed. By forming a CCM or MEA in this manner, a porous network of catalyst particles can be formed on the membrane surface resulting in highly desirable reactant flow toward the 3-phase interface and product flow away from the 3-phase interface.

Spraying

In a preferred aspect of the invention, an ink of the present invention is sprayed with a spray device. As used herein, a “spray device” or “spraying device” is a device that atomizes the ink composition through ultrasonic or shear energy into a plurality of droplets and transfers the droplets entrained in a gas to the substrate surface. For purposes of the present specification, the term “spraying” does not include ink jet printing. The spraying step preferably forms a plurality of droplets having an average droplet size of greater than about 5 μm, e.g., greater than about 10 μm, or greater than about 15 μm. In terms of upper range limits, optionally in combination with these lower range limits, the average droplet size optionally is less than about 20 μm, less than about 15 μm or less than about 100 μm.

More specifically, the step of spraying comprises atomizing the ink to form an aerosol of droplets, the droplets comprising catalyst particles and optionally PEI, and the droplets are then transferred to the substrate surface, preferably the surface of a PEM. The atomization technique employed for generating the droplets has a significant influence over the characteristics of the final catalyst layer formed therefrom. In extreme cases, some techniques cannot atomize inks with even moderate particle loadings or high viscosities.

In various embodiments, the atomization is effected with ultrasonic transducers (e.g., at a frequency of 1-3 MHz); ultrasonic nozzles (e.g., at a frequency of 10-150 KHz); rotary atomizers; two-fluid nozzles; or pressure atomizers.

In one aspect, ultrasonic transducers are submerged in a liquid (the ink) and the ultrasonic energy produces atomized droplets on the surface of the liquid. Two basic ultrasonic transducer disc configurations, planar and point source, can be used. Deeper fluid levels can be atomized using a point source configuration since the energy is focused at a point that is some distance above the surface of the transducer. The scale-up of submerged ultrasonic transducers can be accomplished by placing a large number of ultrasonic transducers in an array. Such a system is illustrated in U.S. Pat. No. 6,103,393 by Kodas et al., the disclosure of which is incorporated herein by reference in its entirety.

Scale-up of nozzle systems can be accomplished by either selecting a nozzle with a larger capacity or by increasing the number of nozzles used in parallel. Typically, the droplets produced by nozzles are larger than those produced by ultrasonic transducers. Gas flow rate should also be controlled. For a fixed liquid flow rate, an increased airflow decreases the average droplet size and a decreased airflow increases the average droplet size. It is generally difficult to change droplet size without varying the liquid or airflow rates. However, two-fluid nozzles have the ability to process larger volumes of liquid per time than ultrasonic transducers.

Ultrasonic spray nozzles also use high frequency energy to atomize the ink. Ultrasonic spray nozzles have some advantages over single or two-fluid nozzles such as the low velocity of the spray leaving the nozzle and lack of associated gas flow. The nozzles are available with various orifice sizes and orifice diameters that allow the system to be scaled for the desired production capacity. In general, higher frequency nozzles are physically smaller, produce smaller droplets, and have a lower flow capacity than nozzles that operate at lower frequencies.

As indicated above, the aerosol can be created using a number of atomization techniques. Examples include ultrasonic atomization, two-fluid spray head, pressure atomizing nozzles and the like. Ultrasonic atomization is preferred for compositions with low viscosities and low surface tension. Two-fluid and pressure atomizers are preferred for higher viscosity compositions. Solvent or other components can be added to the ink composition during atomization, if necessary, to keep the concentration of ink components substantially constant during atomization.

The size of the aerosol droplets can vary depending on the atomization technique. In one embodiment, the average droplet size is not greater than about 100 μm, e.g., not greater than about 80 μm, not greater than about 60 μm or not greater than about 40 μm. In terms of lower range limits, optionally in combination with these upper range limits, the average droplet size optionally is not less than about 5 μm, not less than about 10 μm, not less than about 20 μm or not less than about 30 μm. Some exemplary ranges are from about 5 to about 100 μm, e.g., from about 10 to about 80 μm, or from about 20 to about 60 μm. Thus, in one embodiment, the spraying comprising aerosolizing the ink into a plurality of catalyst-containing droplets, the droplets having an average droplet size of from about 5 to about 100 μm, e.g., from about 10 to about 80 μm, from about 20 to about 60 μm or from about 30 to about 40 μm. Large droplets can be optionally removed from the aerosol, such as by the use of an impactor.

Low aerosol concentrations require large volumes of flow gas and can be detrimental to the deposition of fine features. The concentration of the aerosol can optionally be increased, such as by using a virtual impactor. The concentration of the aerosol can be greater than about 10⁶ droplets/cm³ and more preferably is greater than 10⁷ droplets/cm³. The concentration of the aerosol can be monitored and the information can be used to maintain the mist concentration within, for example, 10% of the desired mist concentration over a period of time.

The droplets may be deposited onto the surface of the substrate by inertial impaction of larger droplets, electrostatic deposition of charged droplets, diffusional deposition of sub-micron droplets, interception onto non-planar surfaces and/or settling of droplets, such as those having a size in excess of about 10 μm.

Spray devices, particularly when coupled with masks or stencils, are also capable of depositing fine features, making them ideal for creating tailored layers within the CCM or MEA which maximize performance while minimizing materials loading. Linear features deposited by spray devices may be any size which will enable sufficient deposition of the requisite materials to create the desired transport, ohmic and kinetic properties within the CCM or MEA while minimizing materials loading within the MEA. Preferably, the linear features have an average width of from about 100 μm to about 1.5 mm, e.g., from about 500 μm to about 1 mm. If desired, the spray device should be capable of depositing an ink composition on a material with minimal line width, particularly when coupled with a mask or stencil. In one embodiment of the present invention, the spray (e.g., aerosol) device can enable the formation of features having a feature width of not greater than about 200 μm, such as not greater than 100 μm,

Spray devices are also advantageous in that they do not require the substrate to be oriented horizontally to deposit the ink compositions. The substrates may be in a vertical or horizontal position or any position there between, in relation to the floor of the facility.

Ideally, each droplet generated by the spray device is identical in composition to the bulk fluid. However, some filtration of the ink composition may occur if the particles are too large to pass through channels or onboard filters. Preferably, the ink compositions include particles having a small particle size and a reduced number of aggregate particle agglomerates to reduce the amount of particles collected by the filter, and preferably allows the removal of the filter.

Examples of tools and methods for the deposition of fluids using spray (aerosol) deposition include U.S. Pat. No. 6,251,488 by Miller et al., U.S. Pat. No. 5,725,672 by Schmitt et al. and U.S. Pat. No. 4,019,188 by Hochberg et al. Each of these U.S. Patents is incorporated herein by reference in their entirety.

The shape of the atomizing surface determines the shape and spread of the spray pattern. Conical, microspray and flat atomizing surface shapes are available. The conical atomizing surface provides the greatest atomizing capability and has a large spray envelope. The flat atomizing surface provides almost as much flow as the conical but limits the overall diameter of the spray. The microspray atomizing surface is for very low flow rates where narrow spray patterns are needed. These nozzles are preferred for configurations where minimal gas flow is required in association with the droplets.

In one embodiment, a sonicating/recirculating system is used to improve the uniformity (dispersion) of the ink and break-up any agglomerations in the ink prior to spraying.

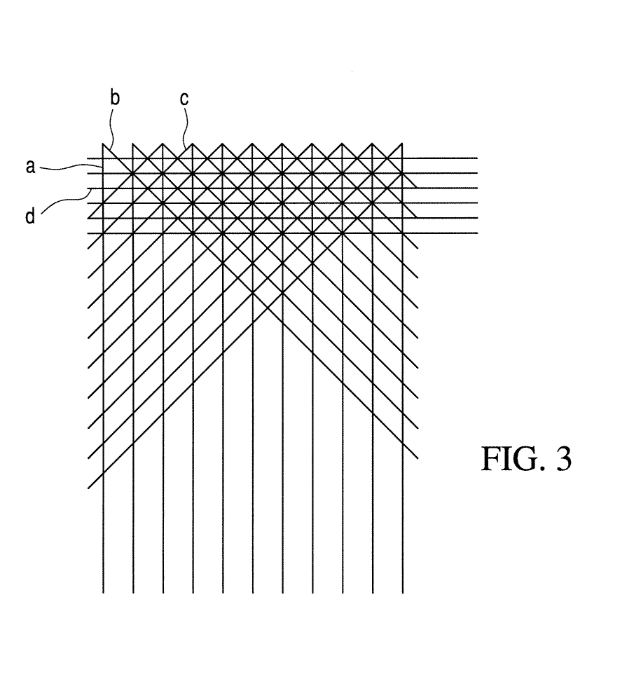

FIG. 3 illustrates a non-limiting exemplary spraying pattern according to one embodiment of the present invention. Other spraying patterns can also be used, of course, as one of ordinary skill in the art of the present invention can appreciate. Spraying of cathode or anode catalyst-containing inks proceeds until a desired number of layers is deposited, for example, from about 3 to about 25 layers, e.g., from about 5 to about 20 layers or from about 7 to about 16 layers. In various optional embodiments, the anode and/or cathode catalyst-containing ink preferably is sprayed until a thickness of from about 10 to about 100 μm, e.g., from about 15 to about 75 μm or from about 20 to about 60 μm is achieved.

The spraying pattern illustrated in FIG. 3 is a delta spray configuration. As shown in FIG. 3, vertical lines “a” are substantially spaced equidistance apart. Each line “a” represents the center spray line of the sprayable anode or cathode catalyst-containing ink sprayed by the spray equipment. Lines “b” are at a 45° angle from line “a” in one direction, and lines “c” are at a 45° angle from line a in another direction. Finally, lines “d”, which are horizontal lines, complete the delta shapes of the centerlines of the sprayable ink. According to exemplary embodiments of the present invention, lines “a” are spaced from about 3 to about 10 mm apart (depending, for example, on the spray area achieved with each pass of the spraying nozzle 34), as are lines “d”. Lines “b” and “c”, which in this instance are at a 45° angle with respect to lines “a”, can also be applied at different angles, forming delta shapes with different measurements, as one of ordinary skill in the art in the present invention can appreciate. Of course, lines a, b, c, and d may be sprayed in any order, and one or more of lines a, b, c, d or may be omitted.

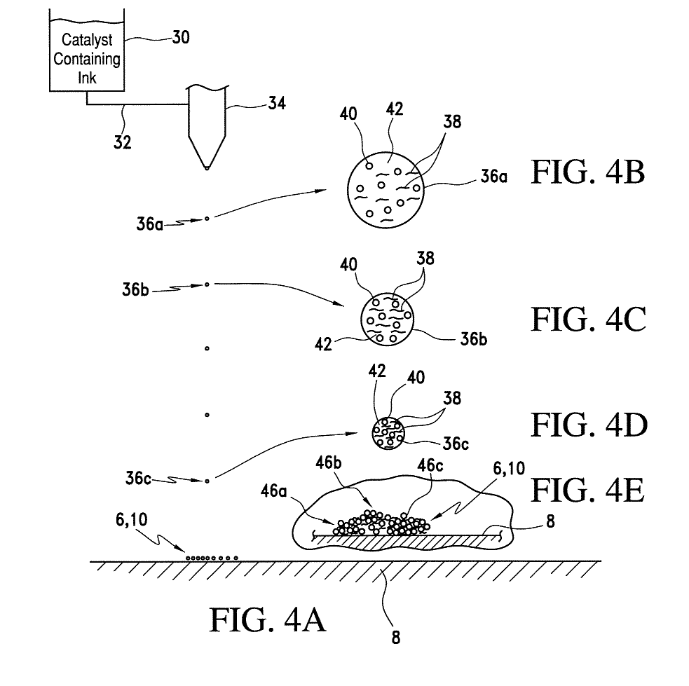

FIGS. 4A-4E illustrate spraying of sprayable cathode or anode catalyst-containing ink on membrane 8 using spraying nozzle 34 according to an embodiment of the present invention. In FIG. 4A, an anode or cathode catalyst-containing ink is held in reservoir 30. The contents of ink source 30 (anode or cathode catalyst-containing ink) are fed to spraying nozzle 34 via nozzle feed tube 32. The catalyst-containing ink comprises a plurality of catalyst particles (anode or cathode particles) 40, PEI 38 (e.g., NAFION® and vehicle 42. Particles 40 are optionally from about 1-30 μm in diameter and are suspended in vehicle 42, which, according to an exemplary embodiment of the present invention, comprises water. As they exit spraying nozzle 34, the catalyst-containing ink droplets preferably have an average droplet size ranging from about 5 μm to about 100 μm, e.g., from about 10 μm to about 80 μm or from about 20 μm to about 60 μm, preferably about 40 μm.

Spraying nozzle 34 sprays anode or cathode catalyst-containing ink that is fed to it in a finely controlled aerosol or mist spray. In one embodiment, membrane 8 is held onto platen 64, which is preferably heated to a temperature, e.g., a temperature of from about 50° C. to about 80° C. As the catalyst-containing ink is forcibly ejected from nozzle 34, vehicle 42 substantially or partially evaporates, and, upon contacting the membrane 8 (or a previously applied catalyst layer), the catalyst particles 40 and electrolyte particles 38 adhere to the surface of membrane 8 (or a previously applied catalyst layer) as agglomerates 46. FIG. 4B illustrates a first droplet 36a as it is ejected from spraying nozzle 34. In droplet 36a electrolyte particles 38 and catalyst particles 40 are held together by vehicle 42. In FIG. 4C, some of vehicle 42 has evaporated, and the electrolyte particles 38 and catalyst particles 40 are more concentrated (closer together) within droplet 36b. In FIG. 4D, approximately 50% by weight of vehicle 42 has evaporated, and droplet 36c is very near to the surface of membrane 8. As the vehicle is fully removed, agglomerates 46 are formed on the membrane 8, which agglomerates comprise a porous mixture of electrolyte particles 38 and catalyst particles 40. FIG. 4E illustrates the formation of catalyst layer 6, 10 (anode or cathode) of the agglomerates 46 upon membrane 8. At this point, substantially all of vehicle 42 has evaporated. In other embodiments, however, as discussed herein, it is desired for the sprayed ink in a previously sprayed layer to remain substantially or partially wet when a subsequent layer is sprayed thereon so as to form highly porous multiple stacked layers.

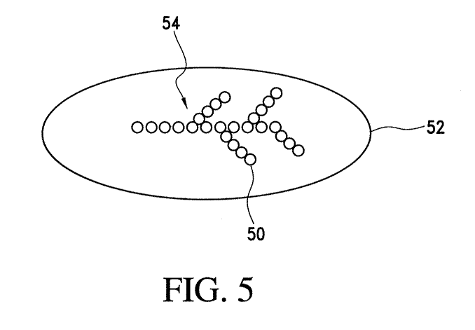

As discussed above and as shown in FIGS. 4B-4E, the droplets preferably are substantially spherical in morphology. In contrast, FIG. 5 illustrates a traditional carbon-supported catalyst droplet 52 comprising a plurality of carbon particles 50, held in suspension in a liquid carrier, e.g., water. The carbon particles 50 in the carbon catalyst droplet 52 form carbon catalyst structures 54 that are linear, branched, tree-like shapes, as seen in FIG. 5. When deposited, the carbon catalyst structures dry on the surface of membrane 8 to form a dense layer of carbon catalyst. This type of carbon catalyst layer is less porous than the catalyst layers formed according to the present invention and not particularly efficient in oxidizing methanol, nor in passing the protons to membrane 8. Furthermore, because of the inherent non-spherical shape of the carbon catalyst structure 54, conventional carbon-supported catalyst particles are generally considered unsuitable for the spraying applications of the present invention.

The arrangement of materials within the catalyst layers is important to achieve optimal functionality of the MEA. As described above, the anode catalyst layer in a DMFC is responsible for oxidizing methanol and therefore the anode catalyst layer must be porous to liquid methanol so that the methanol can reach the active sites within the catalyst layer. Moreover, once the hydrogen ions and electrons have been formed, the electrons should be transported to the bipolar plate, which is generally achieved through a conducting network of catalyst particles. Therefore, the anode catalyst layers must not be so porous that the electrically conductive materials are not well connected. Additionally, the concentration of methanol is not uniform within the anode and the concentration increases with increasing distance from the PEM. It is thus preferred, according to one embodiment, that the loading of electrocatalyst within the catalyst layer decrease with increasing proximity to the PEM.

Forming Gradients

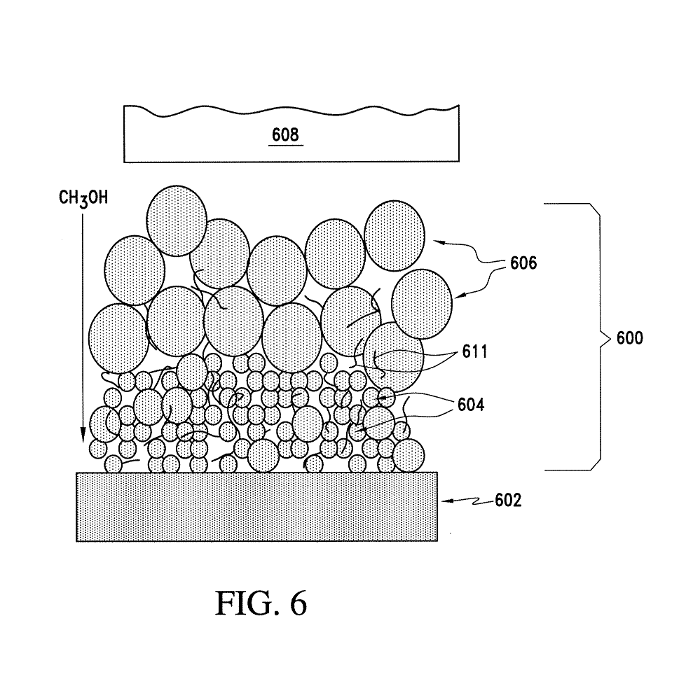

One way to achieve optimal methanol diffusivity without sacrificing electrical conductivity and while simultaneously achieving sufficient electrocatalyst loading is to optimize the porosity and materials loading within the catalyst layer. According to certain embodiments of the present invention, catalyst layers with deliberate variations in catalyst particle size, and/or materials composition (e.g., catalyst particle composition or concentration and/or polymer electrolyte ionomer concentration) can be produced, such as depicted in FIGS. 6 and 8-11. As used in the subsequent discussion, the term “horizontal” refers to a direction that is predominately parallel to the major plane of the PEM surface and the term “vertical” refers to a direction that is predominately perpendicular to the major plane of the PEM surface.

FIG. 6 illustrates a cross-sectional view of an catalyst layer according to an embodiment of the present invention comprising a gradient in particle size in the vertical direction within the catalyst layer. The catalyst layer 600 is disposed between a PEM 602 and a diffusion layer 608 and comprises a first layer comprising larger catalyst particles 606 proximal to the diffusion layer 608 and a second layer of smaller catalyst particles 604 disposed between the layer of larger catalyst particles 606 and the PEM 602. The catalyst layer 600 also comprises PEI 611. Using the DMFC anode catalyst layer as an example, methanol enters the catalyst layer 600 from the diffusion layer 608. The methanol enters the layer of larger catalyst particles 606 and may contact such catalyst particles, thereby becoming oxidized and forming ions, electrons and carbon dioxide. However, due in part to the relatively large voids between the larger catalyst particles, there is a reduced likelihood that methanol will contact the larger catalyst particles and become oxidized. As a result, some of the methanol will diffuse through the layer of larger catalyst particles 606 and reach the layer of smaller catalyst particles 604. However, the change in size of the catalyst particles also reduces the void size and thus the amount of space available for diffusion, which in turn minimizes further methanol diffusion towards the PEM and, in turn, increases the likelihood that methanol will react with an active site within the catalyst layer 600 prior to its reaching the PEM. This structure is also beneficial in that more methanol is likely to react proximal to the PEM, which increases the efficiency of proton transport within the MEA and thus the efficiency of the fuel cell. The electrical conductivity of the catalyst layer is maintained by the intimate contact of the particles.

According to a preferred embodiment, the smaller catalyst particles 604 have an average particle size of at least about 0.3 μm and not greater than about 10 μm, such as from about 0.5 μm to about 10 μm, and the larger catalyst particles 606 have an average particle size of not greater than about 200 μm and preferably at least about 1 μm, such as from about 3 μm to about 100 μm. Catalyst layers comprising vertical gradients in catalyst particle size can be produced using the processes of the present invention, such as by the use of a spray device, described in more detail below, to sequentially deposit the layers. Additionally or alternatively, catalyst layers comprising vertical gradients in catalyst particle size may be effected by spraying successive layers on a substantially or partially wet underlying catalyst layer, as discussed below. The layers 606 and 604 may also comprise catalyst particles with different compositions and/or mass loadings independent of any difference in size. For example, it may be advantageous to put a thin layer of a highly active electrocatalyst material very close to the PEM to ensure that the methanol is consumed, thereby reducing the amount of methanol crossover. The combined thickness of the catalyst layers can be, for example, not greater than about 200 μm.

In a similar embodiment, not shown, the process forms a catalyst layer having a vertical gradient in PEI particle size. For example, the process may form a catalyst layer comprising a first layer comprising PEI of a first size proximal to the diffusion layer and a second layer comprising PEI of a second size disposed between the layer of first PEI and the PEM. In various embodiments, the first size may be greater than or less than the second size. Of course, a PEI particle size gradient comprising more than two layers may also be formed.

Thus, according to the processes of the present invention, gradients in particle size (whether catalyst particle size, PEI particle size, or both) may be formed by spraying a first ink comprising catalyst and/or PEI of a first size to form a first catalyst layer, followed by spraying a second ink comprising catalyst and/or PEI of a second size, different from the first size, on the first layer to form a second catalyst layer on the first catalyst layer. Optionally the first layer is heated prior to deposition of the second layer. The process may be repeated to form a final catalyst layer on the PEM having the desired particle size gradient.

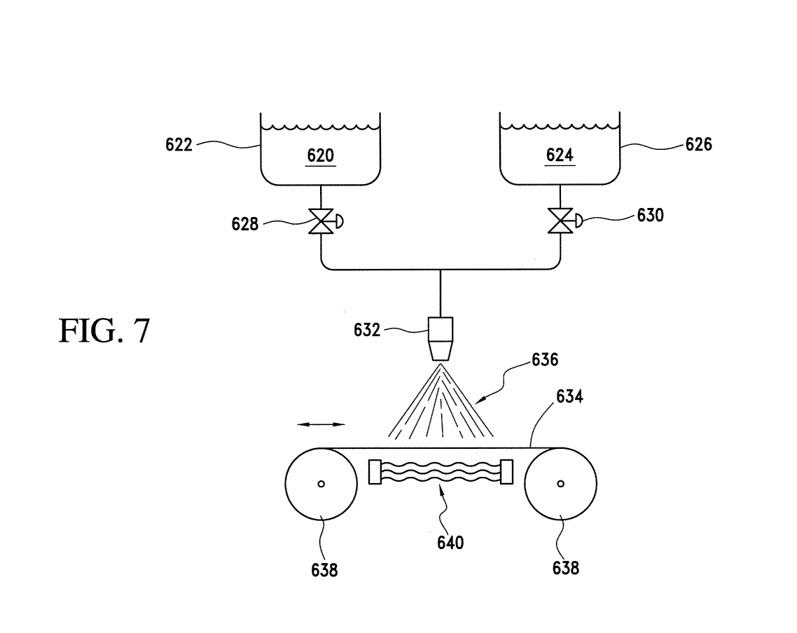

A non-limiting example of a spray device suitable for performing this process is illustrated in FIG. 7. As shown, a first ink 620 comprising first particles (e.g., catalyst particles, PEI, or both) of a first size is contained in a first ink source 622, and a second ink 624 comprising second particles (e.g., catalyst particles, PEI, or both) of a second size is contained in a second ink source 626. Of course, more than two ink sources having inks comprising particles of various additional sizes or compositions may also be employed. The flow of first ink 620 to nozzle 632 is controlled by valve 628, and the flow of second ink 624 to nozzle 632 is controlled by valve 630. Optionally, the first layer is formed by spraying sprayed ink 636 comprising the first ink 620, i.e., with valve 628 open and valve 630 closed, onto substrate 634. After the deposition of first layer on substrate 634, valve 628 is closed and valve 630 is opened to allow second ink 624 to flow to nozzle 632, thereby forming sprayed ink 636 comprising second ink 624. In this manner, second ink 624 can be sprayed onto substrate 634 to form a second layer on top of the first layer. Additional layers may also be formed on top of the second layer in order to form a final catalyst layer. Optionally, the first layer is heated, for example by heat source 640, prior to and/or simultaneously with spraying of the second ink 624 to remove at least a portion of the vehicle contained in the first ink 620 prior to deposition of the second ink 624. In FIG. 7, substrate 634 is illustrated as a movable PEM disposed between a pair of rollers 638, although many other substrate configurations are possible. Additionally, it may be desirable to employ a mask or stencil (not shown) between nozzle 632 and substrate 634 to better control where sprayed ink 636 contacts substrate 634.

In another aspect of the present invention, the relative concentrations of the particles (e.g., catalyst particles, PEI, or both) of the first size and of the second size being sprayed to form a particular catalyst layer are carefully controlled by mixing at least a first portion of the first ink 620 with a second portion of the second ink 624, e.g., through manipulation of valves 628 and 630. Thus, the concentrations of the first particles and second particles contained in sprayed ink 636 can be carefully controlled and varied in each respective layer that is deposited on substrate 634. In this manner, final catalyst layers having a very gradual particle size gradient (e.g., catalyst particles size gradient, PEI particle size gradient or both) desirably may be formed on substrate 634. The varying of first particle and second particle concentration in sprayed ink 636 may be performed manually and/or by employing a computer, software, servos and/or other robotic devices to manipulate valves 628 and 630 and, after deposition of multiple catalyst layers, form a final catalyst layer having virtually any desired particle size gradient.

In another embodiment, not shown, a vertical gradient comprising compositionally different catalyst particles may be formed, for example, from two or more inks, at least two of the inks, respectively, comprising compositionally different catalyst particles from one another, e.g., different active species or support phase. For example, a first ink comprising a first type of catalyst particles may be sprayed onto a membrane following by a second spraying step comprising spraying a second ink comprising a second type of catalyst particles on top of the previously applied catalyst layer comprising the first catalyst particles.

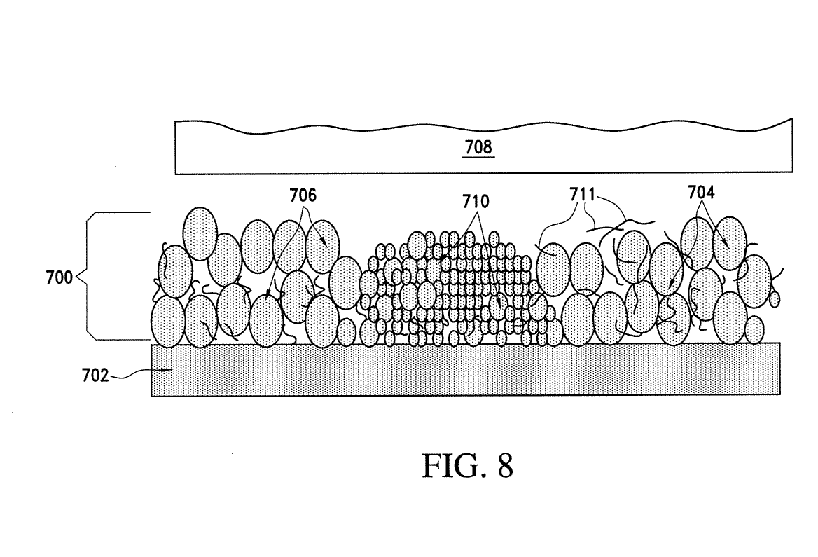

FIG. 8 illustrates a cross-sectional view of a catalyst layer comprising a gradient in catalyst particle size in the horizontal direction within the catalyst layer. The catalyst layer 700 is disposed between a PEM 702 and a diffusion layer 708 and comprises first regions of larger catalyst particles 704 and 706 and second regions of smaller catalyst particles 710 disposed among the regions of larger catalyst particles 704 and 706. Catalyst layer 700 also comprises PEI 711. Using the DMFC anode catalyst layer as an example, methanol enters the catalyst layer 700 from the diffusion layer 708. Following the path of least resistance, the methanol is more likely to diffuse away from the regions of smaller catalyst particles 710 and toward the regions of larger catalyst particles 704 and 706. As a result, methanol transport in the horizontal direction will be increased, thereby decreasing the probability of crossover. Preferred particle sizes for the first and second regions are as described above with respect to FIG. 6. The different regions of larger catalyst particles and smaller catalyst particles can be disposed on the PEM in a variety of patterns, such as a checkerboard pattern and the different regions can be of virtually any shape or size. The concentration of the regions on the PEM can also vary—for example, the concentration of regions with larger catalyst particles (e.g., regions 704 and 706) can increase toward the perimeter of the PEM to enhance horizontal transport of the liquid fuel across the full surface of the catalyst layer. In another embodiment of the present invention, the catalyst composition can be different in the region denoted by 710 as compared to the regions denoted by 704 and 706. Catalyst layers comprising horizontal gradients in particle size can be produced using the methods of the present invention, such as by the use of spray devices, according to the present invention. In a similar embodiment, not shown, the catalyst layer may comprise a horizontal gradient in the size of the PEI 711 contained therein.

Referring back to FIG. 7, in one aspect of the present invention, a catalyst layer 700 having a particle size gradient in the horizontal direction may be formed by varying the respective concentrations of the first particles (of a first size) derived from first ink 620 and second particles (of a second size) derived from second ink 624 that are contained in sprayed ink 636 while moving either or both substrate 634 and/or nozzle 632 in the horizontal direction. For example, after depositing a first sprayed ink having a first concentration of first and second particles (e.g., catalyst particles, PEI or both), respectively, in a first region of substrate 634, the substrate and/or nozzle 632 can be moved to a second (horizontal) region of substrate 634. Additionally, after spraying of the first sprayed ink, valves 628 and 630 are manipulated to provide a second sprayed ink having a second concentration of first and second particles (e.g., catalyst particles, PEI or both), respectively, that is different from the first concentration of first and second particles that was contained in the first sprayed ink. Then, the second sprayed ink is sprayed onto the second region of substrate 634. In this manner, particles of different sizes can be sprayed onto different horizontal regions of substrate 634 to form a final catalyst layer having a horizontal particle size gradient, for example, a horizontal catalyst particle size gradient, a horizontal PEI particle size gradient, or both.

In another embodiment, a horizontal gradient comprising compositionally different catalyst particles may be formed, for example, from two or more inks, at least two of the inks, respectively, comprising compositionally different catalyst particles from one another, e.g., having different active specie or support structures. For example, a first ink comprising a first type of catalyst particles may be sprayed onto a membrane following by a second spraying step comprising spraying a second ink comprising a second type of catalyst particles adjacent the previously applied catalyst layer comprising the first catalyst particles.

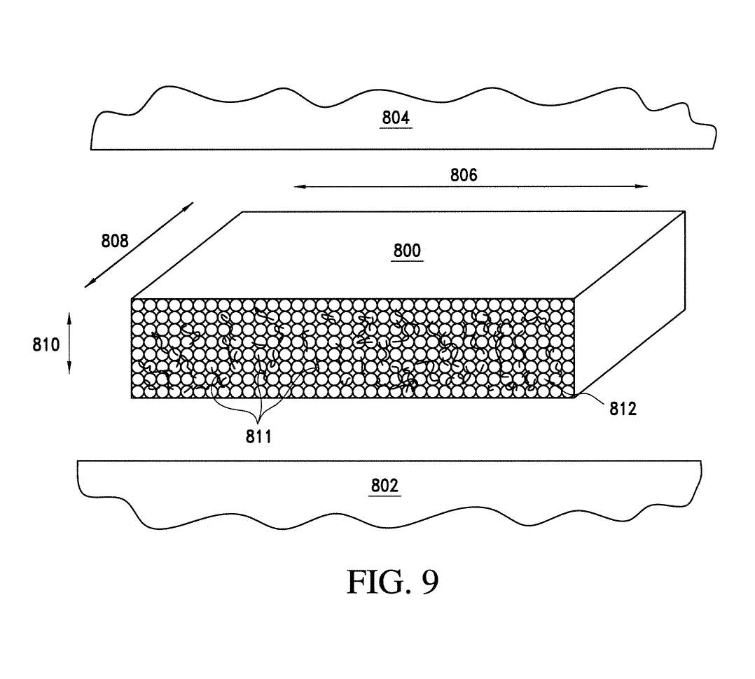

FIG. 9 illustrates an exploded view of an CCM (not to scale) comprising a catalyst layer with one or more concentration gradients within the catalyst layer, such as a gradient in concentration of catalyst particles, PEI or a combination thereof. The catalyst layer 800 is disposed between a PEM 802 and a diffusion layer 804 and comprises catalyst particles 812 and PEI 811, the catalyst layer having a length 806, width 808 and a depth 810. The catalyst layer 800 comprises a deliberate gradient in the concentration of either or both the catalyst particles 812 and/or the PEI 811 within the catalyst layer, the layer and gradient being produced using a spray device in accordance with the present invention. In one embodiment of the present invention, the concentration of a material within the catalyst layer varies along at least one of the length 806, width 808 or depth 810 of the catalyst layer.

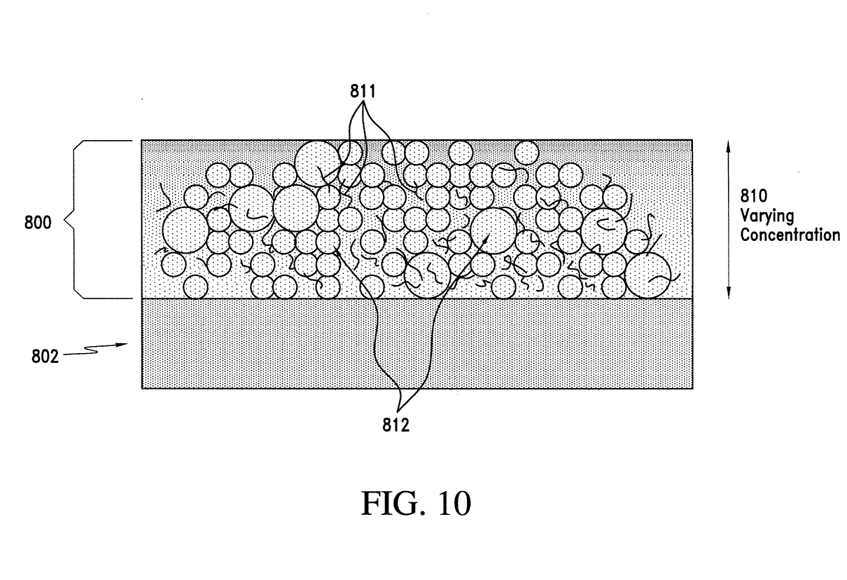

In a preferred embodiment, illustrated in cross-section in FIG. 10, the concentration of either or both catalyst particles 812 and/or PEI 811 varies along the depth 810 of the catalyst layer 800. In one preferred embodiment, the concentration of either or both of these materials proximal to the PEM 802 is greater than the concentration of the same material proximal to the diffusion layer (not illustrated), opposite the PEM. This embodiment is useful, for example, in preventing cross-over without materially limiting the ability of the methanol to reach the active sites within the catalyst layer 800.

In a manner similar to the embodiment described above with reference to FIG. 6 and FIG. 7, catalyst layers having concentration gradients (of either or both catalyst particles or PEI) in the vertical direction may be formed, for example, by depositing a first ink having a first concentration of particles (e.g., catalyst particles, PEI or both) in a first layer on a substrate followed by spraying a second layer on the first layer comprising a second concentration of particles. Preferably, the first ink has a weight ratio of PEI to catalyst particles that is different from (e.g., greater than or less than) the weight ratio of these particles in the second ink. Optionally the first layer is heated after or during the spraying of the second ink to form the second layer. Of course, more than two layers may be formed on the substrate.

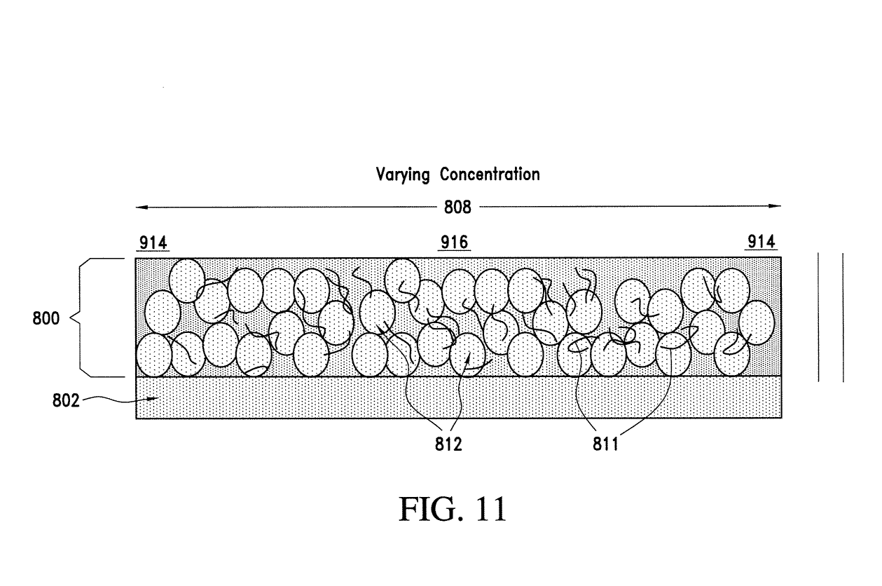

In another preferred embodiment, illustrated in cross-section in FIG. 11, the concentration of either or both catalyst particles 812 and/or PEI 811 varies along the width of the catalyst layer. Preferably, there are one or more regions 914 in the catalyst layer 800 where the concentration of one or both the catalyst particles 812 and/or PEI 811 is greater than the concentration of these material(s) in other region(s) 916, wherein the regions are disposed horizontally with respect to one another. This embodiment is useful for matching the properties of the electrode layer with the gas or liquid flow.

Catalyst layers having concentration gradients (of either or both catalyst particles or PEI) in the horizontal direction may be formed, for example, by spraying a first ink having a first concentration of particles (e.g., catalyst particles, PEI or both) in a first region of a substrate followed by spraying a second ink having a second concentration of particles layer on the first layer comprising a second concentration of particles (e.g., catalyst particles, PEI or both) in a second region of the substrate, wherein the first and second regions are horizontally disposed with respect to one another. Preferably, the first ink has a weight ratio of PEI to catalyst particles that is different from the weight ratio of these particles in the second ink. This process may be effected by moving either or both the substrate and/or the nozzle horizontally so that the first and second inks, respectively, contact different horizontally disposed regions of the substrate. Thus, in one embodiment of the invention, the spraying step optionally comprises (i) spraying a first portion of a membrane with a first ink mixture comprising a liquid vehicle, a first catalyst amount of catalyst particles and a first PEI amount of PEI; and (ii) spraying a second portion of the membrane with a second ink mixture comprising a second the liquid vehicle, a second catalyst amount of catalyst particles, and second PEI amount of PEI, under conditions effective to form a catalyst gradient and/or PEI gradient on the membrane.

While simple 1-dimensional concentration gradients along the width and depth of the catalyst layer are illustrated, the concentration gradient may be produced in any direction within the catalyst layer and in two or three-dimensions. For example, a concentration gradient could be deliberately varied in both X and Y directions or along X, Y and Z directions. Moreover, the concentration gradients described above may be used in combination with the particle gradients described above to create a catalyst layer which includes deliberate gradients in both particle size and concentration of functional materials within the layer. Similarly, as discussed above, the gradients, whether by concentration or size, may be with respect to the catalyst particles, the PEI, or both. Further, as discussed above, the gradients may be with respect to catalyst particles having different compositions.

If each ink composition is sprayed one on top of the other and the inks are dried between each consecutive sprayed step, then the compositional interface between the layers derived from each ink composition will be sharp. However, if each ink composition is sprayed one on top of the other, and the inks remain at least partially wet during the deposition steps, then there will be diffusion between the layers derived from each ink composition resulting in a gradient in composition rather than a sharp concentration change at the layer interface. Thus, spray processes enable sequential spraying of wet layers to achieve a gradient in composition at the interface between the ink layers and therefore within the electrode layer.

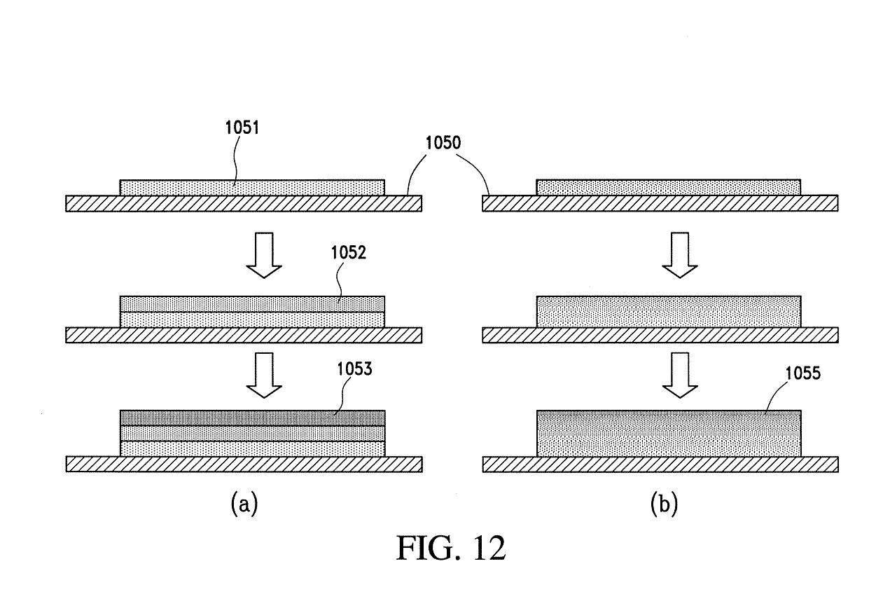

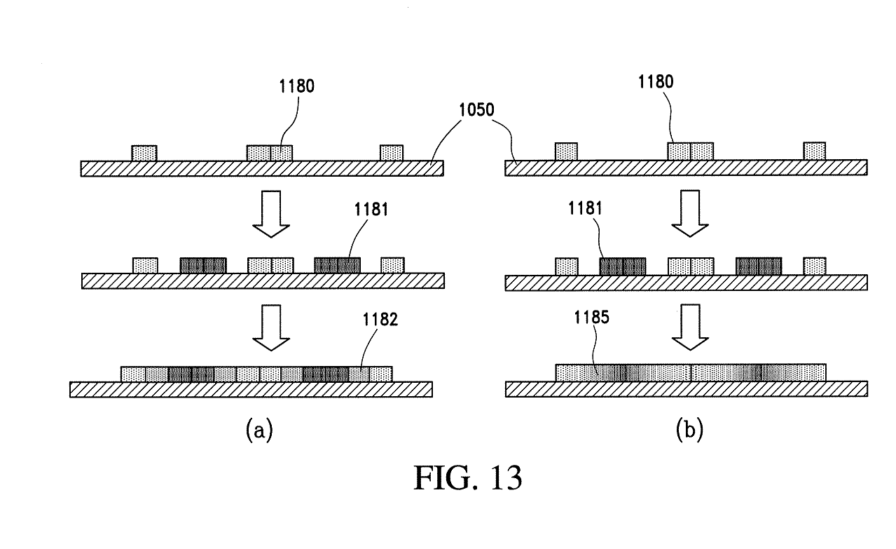

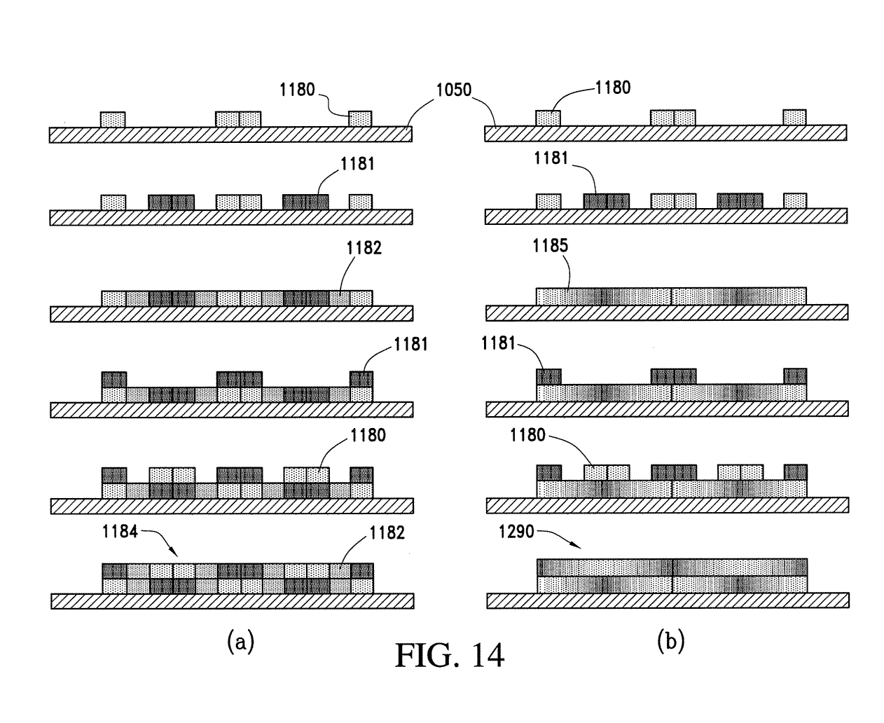

By combining the above-described processes, electrode layers can be fabricated having a gradient in concentration in the vertical direction, the horizontal direction or a combination of vertical and horizontal directions. Schematic illustrations of different types of spray deposited electrodes that can be created are shown in FIGS. 12 to 14. FIG. 12 shows the construction of a concentration gradient in the vertical direction, FIG. 13 shows a concentration gradient constructed in the horizontal direction and FIG. 14 shows concentration gradients constructed to be a combination of the vertical and horizontal directions.

Referring to FIG. 12a, a substrate 1050, e.g., PEM substrate, has a first material layer 1051 sprayed onto its surface with a first ink composition that includes at least a first functional material, e.g., catalyst particles and/or PEI. The first layer/ink is dried, e.g., by heating, and then a second layer 1052 derived from a second ink composition is sprayed onto the surface of the first layer 1051. The second layer 1052 is then dried and a third layer 1053 is sprayed from a third ink composition and the layer is dried. Each of the first, second and third inks has a different composition and each composition can include different functional materials (e.g. different catalyst particle compositions) and/or different concentrations of functional materials. The resulting structure is comprised of three individual layers with sharp changes in concentrations at the interface.

FIG. 12b shows a similar strategy, but where the three different inks are sprayed in layers and the inks are not allowed to completely dry between spraying and there is significant diffusion between the individual layers resulting in the formation of a final structure 1055 which has a more uniform gradient distribution across the depth of the structure.

FIGS. 13a and 13b show a similar approach for spraying gradients in composition along the horizontal direction using three different ink compositions. In FIG. 13a, three different ink compositions are sprayed in the three different areas indicated 1180, 1181 and 1182 and allowed to dry between each spraying step, resulting in sharp compositional interfaces between the different sprayed regions. In FIG. 13b, the three different ink compositions are sprayed in a similar pattern but remain wet, or are only partially dried, and when the final ink is sprayed the contents of the layers are able to diffuse to form a more uniform gradient structure 1185. In contrast to FIG. 12, FIG. 13 shows how a gradient structure can be formed horizontally on the substrate surface versus vertically with respect to the substrate surface.

FIGS. 14a and 14b illustrate an extension of the construction of the gradient compositional structure shown in FIGS. 12 and 13. The top three structures of FIGS. 14a and 14b are constructed analogously to FIGS. 13a and 13b from three different inks with concentration variation dictated by the drying steps. A first pattern of regions 1180 is formed from a first ink composition by spraying onto a substrate 1050. A second pattern of regions 1181 is formed from a second ink composition that is different than the first ink composition. A third pattern of regions 1182 can then be formed, the third ink composition being different than the first and second ink compositions. The lower three structures of FIGS. 14a and 14b are sprayed using the same three inks as the top three structures, where the structures in FIG. 14a are dried prior to spraying the next ink versus not drying the ink between the steps in FIG. 14b. The result is two different 3-dimensional structures with concentration gradients controlled both vertically and horizontally with respect to the substrate surface 1050, where the final structure 1184 is highly segmented in the case of FIG. 14a, but the structure 1290 is more uniform in the case ofFIG. 14b.

Producing cost-effective CCMs and MEAs generally requires a manufacturing method that is able to deposit the desired materials in a desired pattern and in a short amount of time, is able to adapt to changes in materials and deposition patterns quickly, is cost-effective in terms of both materials used and down-time, and has the ability to align the various layers of the CCM or MEA within given tolerances, all without sacrificing the performance of the CCM or MEA. The methods according to the present invention using spray devices allow not only the flexibility to produce the patterns required to achieve the structures indicated but enable the spraying of multiple layers in which the drying characteristics can be carefully controlled. For example, spraying one wet layer on top of another wet layer enables diffusion of the materials between the layers to create a compositional gradient. There are relatively few, if any, spraying processes which enable the sequential deposition of wet layers. At the opposite extreme, the layers can be dried between the sequential spraying steps to provide a sharp interface in the composition between the two layers.

According to one preferred embodiment of the present invention, it is advantageous to manufacture one or more layers of the CCM or MEA by depositing an ink composition comprising catalyst particles and PEI, and optionally one or more materials selected from the group consisting of HPO, ELC, additives and combinations thereof using a spray device. The spray device is preferably controllable over an x-y grid relative to the sprayed surface (i.e., either or both the substrate and device can be controllably moved) such that patterns can be formed on the substrate.

Spray devices can also be controlled using digital technology, which enables digital spraying. Digital technology, as used herein, means any technological device which is capable of generating and/or sending one or more digital signals to a spray device to control the device and includes the use of computers. As used herein, the term digital spraying means the use of digital technology in conjunction with a spray device to deposit materials on a substrate.

Digital spraying is advantageous for several reasons. Digital spraying enables the deposition of materials on a substrate without direct human interaction. This increases safety in the manufacturing facility by minimizing human interaction with machinery and harmful chemicals. Minimizing human interaction with the manufacturing process also eliminates the probability of human error during spraying.

Digital spraying also enables the use of computer generated deposition patterns. With the use of digital spraying, the use of a physical material with an engraved deposition pattern is no longer necessary to enable the deposition of materials in a desired pattern. With digital spraying, deposition patterns can be created in a computer software environment (“digital patterns”) making the design and generation of deposition patterns easy and cost-effective. Digital patterns can also be changed quickly and without requiring a change to an engraved physical material, which further reduces capital costs. Such a pattern change may be made during manufacture or design with little or no difficulty.

The use of digital spraying can achieve changes in deposition patterns very quickly, often less than a second, leading to minimal manufacturing down-time and increased productivity. According to one embodiment of the present invention the time to switch between deposition patterns and resume spraying of the ink composition is very small, on the order of a few seconds. Preferably, the time elapsed from the end of the spraying of an ink composition in a first spraying pattern to the start of the spraying of an ink composition in a second deposition pattern is less then 5 seconds, more preferably is less than 3 seconds and even more preferably is less than 1 second.

Digital spraying also facilitates the contemporaneous deposition of more than one ink composition in one or more deposition patterns. Often it may be necessary to deposit more than one material in order to manufacture a fuel cell with the desired transport characteristics. It is often desirable to deposit all materials at a single manufacturing station to decrease the time of manufacture.

Digital spraying also facilitates the contemporaneous deposition of one or more ink compositions in one or more deposition patterns on opposing sides of a substrate which increases the probability of proper material alignment within the CCM or MEA. Alignment of the catalyst layers with the PEM and corresponding diffusion layers is critical to ensure optimal functionality of the fuel cell. Moving the substrate between spraying steps can lead to alignment discrepancies between the various deposition steps. Contemporaneous materials deposition on one or opposing sides of a substrate (e.g., the PEM) according to the present invention helps increase the probability of correct alignment between the various components of the fuel cell by eliminating the need to move the substrate between deposition steps. For these and other reasons, digital spraying makes the manufacturing process easier and more cost-effective.

According to one embodiment of the present invention, a process is provided wherein the substrate is not moved between manufacturing stations between two or more deposition steps. As used herein, a manufacturing station is any location within a facility wherein material(s), (e.g., a PEM, bipolar plate, gas or fluid distribution substrate, or an catalyst layer or diffusion layer thereon) are expected to undergo treatment and/or be combined with another substrate with the purpose of effecting the construction of a CCM or MEA.

Spray devices are also advantageous in that they are generally capable of depositing most or all materials necessary to create the various layers and components of the CCM or MEA. This enables the use of a single manufacturing step to deposit most or all of the materials required for the construction of the CCMs or MEAs. As discussed above, a variety of materials are necessary to successfully fabricate a CCM or an MEA. Spray devices are generally compatible with the necessary functional materials and thus can complete the deposition of such materials at a single manufacturing station. This increases the productivity of the manufacturing process by decreasing the amount of steps and manufacturing stations necessary to fabricate the CCM or MEA. Deposition at a single manufacturing station also increases the probability that the deposited materials will be located within tolerable proximities by eliminating errors in substrate alignment created from moving the substrate between stations. As used herein, the term “compatible” generally refers to the fact that the materials used during the deposition by the spray device are capable of being deposited by the spray device and the spray device is generally inert to the materials.

The use of spray devices also facilitates better control over the construction of interfaces and layer compositions enabling the formation of tailored gradients in composition and enabling the formation of a layer surface morphology that facilitates chemical transport and electrochemical reactions as described above. The use of a spray device facilitates the construction of features with combined functionalities such that multiple layers can now be combined into a single layer with multiple functionalities thereby providing benefits in both performance and energy density.

Spray devices are also advantageous in that it is possible to spray gradient layers of material wherein the composition of the sprayed layer varies, as is discussed above. Spray devices are also advantageous in that they do not contact the surface on which the ink composition is deposited. It is therefore possible to form features and create device components on a non-planar surface, if required, for a specific application or product geometry.

In the foregoing embodiments, the ink compositions may be deposited by a single spray device or a plurality of spray devices, each using one or more spray nozzles. The ink compositions may be deposited on one side of the substrate or both sides of the substrate. The ink compositions may be deposited contemporaneously or sequentially. For example, a first ink composition may be contemporaneously or sequentially deposited on opposing sides of the PEM. Subsequently, a second ink may be deposited on the previously created layer(s) or substrates. The ink compositions may comprise any of the aforementioned catalyst particles, PEI, and combinations thereof.

Vaporization of Deposited Ink

As indicated above, after the ink is deposited, preferably sprayed, on a substrate, preferably a PEM substrate, the vehicle in the deposited ink is vaporized under conditions effective to form a catalyst layer on the membrane. Preferably, the step of vaporizing the deposited ink comprises heating the deposited ink, preferably at a low temperature, e.g., less than about 300° C., under conditions effective to vaporize at least a portion of the vehicle. In the process, the depositing and vaporizing steps are alternated, e.g., at least 3 times, at least 5 times, at least 10 times or at least 15 times, to form multiple stacked catalyst layers on the membrane. The in-situ formation of the catalyst at low temperatures enables the catalyst to be deposited and formed on a variety of substrates, including polymer membranes.

By alternating the depositing and vaporizing steps to form a final catalyst layer comprising multiple stacked catalyst layers, highly porous catalyst layers can be formed. Porosity, as is understood by those of ordinary skill in the art of the present invention, describes how densely a certain material is packed. Porosity can be defined by the amount of non-solid volume to the total volume of a material, although as one of ordinary skill in the art knows, other definitions exist. Porosity (Φ) can be defined, for example, by the following ratio:

$$Φ = \frac{{V}_{p}}{{V}_{m}} \qquad ( 2 )$$

wherein Vₚ is the non-solid volume (pores and liquid) and Vₘ is the total volume of material, including the solid and non-solid parts. According to this ratio, the porosity value is a fraction, between 0 and 1, with porosity increasing as the value approaches 1. According to exemplary embodiments of the present invention, catalyst layers having a porosity in the range of from about 0.20 to about 0.60, e.g., from about 0.30 to about 0.55 or from about 0.40 to about 0.50, can be formed.

In a preferred aspect of the invention, at least once during the repeating sequence of depositing and vaporizing steps, and preferably during a plurality of or all but the last of the repeating sequence of depositing/vaporizing steps, the vaporizing comprises vaporizing some, but not all, of the vehicle that was contained in the ink when it was deposited on the substrate. For example, the vaporizing optionally comprises vaporizing less than about 99 weight percent, less than about 90 weight percent, less than about 80 weight percent, less than about 70 weight percent, less than about 60 weight percent or less than about 50 weight percent of the vehicle, based on the total weight of the vehicle in the ink as the ink contacts the substrate. In terms of lower limits, optionally in combination with these upper limits, the vaporizing optionally comprises vaporizing at least about 30 weight percent, at least about 40 weight percent, at least about 50 weight percent, at least about 60 weight percent, at least about 75 weight percent or at least about 80 weight percent of the vehicle, based on the total weight of the vehicle in the ink as the ink contacts the substrate. In some exemplary preferred embodiments, the vaporizing comprises vaporizing from about 40 to about 90 weight percent, e.g., from about 50 to about 80 weight percent or from about 60 to about 70 weight percent of the vehicle, based on the total weight of the vehicle in the ink as the ink contacts the substrate. In these embodiments, as indicated above, it should be emphasized that these ranges refer to the amount of vehicle vaporized during one or more intermediate (i.e., not final) vaporizing steps. In contrast, after the last (final) depositing step, e.g., spraying step, in the sequence of depositing/vaporizing steps, the vaporizing preferably comprises vaporizing substantially all of any remaining vehicle contained in the deposited ink and contained in any underlying ink layers so as to form a substantially dry final catalyst layer, which is comprised of multiple stacked catalyst layers.

Additionally, the use of an ink comprising catalyst particles of various sizes (e.g., having a broad PSD and/or a multimodal particle size distribution) may be beneficial in forming a porosity gradient in a catalyst layer from a single ink, particularly wherein each successive catalyst layer is formed on a wet or partially wet underlying layer. Specifically, it has been surprisingly and unexpectedly discovered that by spraying a subsequent layer on an underlying wet or partially wet catalyst layer, smaller catalyst particles in one layer may selectively migrate into underlying layers, e.g., between the pores of underlying layers, due to gravity such that the catalyst layers that are proximally oriented with respect to the membrane tend to have a greater degree of packing and hence a lower porosity than the catalyst layers that are distally oriented with respect to the membrane. Further, the degree of the porosity gradient can be controlled by controlling the amount of vehicle that is vaporized between the formation of each successive catalyst layer. Generally, the greater the degree of vaporization before a subsequent layer is sprayed, the less migration will occur. The amount of vehicle vaporized between the successive layers may be controlled, for example, by controlling the temperature of the membrane and/or controlling the time elapsed between the formation of successive layers. Thus, in another aspect of the invention, the process includes a step of controlling porosity in the multiple stacked catalyst layers by controlling the amount of vehicle that is vaporized in each alternating vaporizing step. Thus, the amount of vehicle vaporized in each alternating vaporizing step optionally increases or, alternatively, decreases so as to create a porosity gradient in a direction perpendicular to the surface of the membrane.

Thus, in another embodiment, the invention is to a catalyst coated membrane comprising a polymer electrolyte membrane having a first surface and a first catalyst layer disposed thereon, wherein the first catalyst layer has a porosity gradient in which porosity increases in a direction extending away from the first surface. Optionally, the polymer electrolyte membrane further comprises a second surface, and the catalyst coated membrane further comprising a second catalyst layer disposed on the second surface. Preferably, the first catalyst layer and/or the second catalyst layer comprises polymer electolyte ionomer and catalyst particles.

In a related embodiment, the invention is to a process for forming a catalyst coated membrane having a desired catalyst layer porosity, which process employs a correlation between catalyst layer porosity and membrane temperature. In this embodiment, the invention comprises the steps of: (a) providing a correlation between catalyst layer porosity and membrane temperature; (b) employing the correlation to determine a target membrane temperature based on the desired catalyst layer porosity; (c) heating a membrane to the target membrane temperature; and (d) depositing, e.g., spraying, an ink comprising catalyst particles and a vehicle onto the heated membrane, wherein heated membrane vaporizes the vehicle and forms a catalyst layer having the desired catalyst layer porosity. In this embodiment, step (d) preferably is repeated in several passes to form multiple stacked catalyst layers.

Thus, the temperature of the membrane may significantly influence the degree of porosity of the ultimately formed catalyst layer. Accordingly, in a preferred embodiment, in the vaporizing step the substrate, e.g., PEM, is heated and imparts heat to each deposited ink layer formed thereon. As described above, the precise temperature(s) employed during the vaporizing steps may vary widely, depending, for example, on the desired porosity for the ultimately formed catalyst layer(s) as well as the properties (e.g., volatility) of the ink(s) employed. In various optional embodiments, the vaporizing comprises heating the deposited ink to a temperature greater than about 50° C., e.g., greater than about 60° C. or greater than about 70° C. In terms of upper limits, optionally in combination with these lower limits, the temperature optionally is less than about 350° C., e.g., less than about 300° C., less than about 250° C., less than about 200° C., less than about 150° C. or less than about 10020 C. In some exemplary preferred embodiments, the vaporizing optionally comprises heating the deposited ink to a temperature from about 50° C. to about 100° C., e.g., from about 60° C. to about 80° C., preferably about 70° C., at least once during the sequence of depositing and vaporizing steps.

In one embodiment, the temperature of the substrate is maintained relatively constant throughout the process of the present invention so as to form catalyst layers having a relatively uniform porosity throughout. Alternatively, a porosity gradient may be created in the catalyst layers by varying the temperature profile during the sequence of repeating depositing and vaporizing steps. For example, by heating ink layers that are proximally oriented with respect to the substrate at a temperature different from ink layers deposited distally relative to the substrate, the porosity of the ultimately formed catalyst layers that are proximal to the substrate will tend to be different from the porosity of those layers oriented distally with respect to the substrate. Providing a porosity gradient may be beneficial, for example, in facilitating reactant/product transport in an MEA.

Additionally, if the ink comprises a molecular metal precursor, the heating preferably is effective to convert the molecular metal precursor to its corresponding metal, which preferably comprises a catalytically active species. The metal may form as individual particles, e.g., nanoparticles, in the catalyst layer formed, and/or may form active sites dispersed on a support phase if the ink also contained support particles.

Preferably, the ink compositions can be confined on the substrate after deposition, thereby enabling the formation of features having a small minimum feature size, the minimum feature size being the smallest dimension in the x-y axis, such as the width of an catalyst layer. If desired, the ink composition can be confined to regions having a width of not greater than 100 μm, preferably not greater than 75 μm, more preferably not greater than 50 μm, even more preferably not greater than 25 μm, and even more preferably not greater than 10 μm, such as not greater than about 5 μm. Small amounts of rheology modifiers such as styrene allyl alcohol (SAA) and other polymers can be added to the ink composition to reduce spreading. The spreading can also be controlled through the use of combinations of nanoparticles and molecular precursors. Spreading can also be controlled by rapidly drying the compositions during (or immediately after) spraying, such as by irradiating the composition during deposition.

Spreading can also be controlled by the addition of a low decomposition temperature polymer in monomer form. The monomer can be cured during deposition by thermal or ultraviolet means, providing a network structure to maintain feature shape. The polymer can then be either retained or removed during subsequent processing.

Ideally, the amount of materials used to create the layers is minimized by selectively depositing the materials only where needed in the CCM or MEA. As a result, the volume of the electrocatalyst and other layers is minimized resulting in reduced material and capital costs. As catalyst materials are generally the most expensive materials used in the fabrication of the MEA, it is important to minimize the amount of catalyst loading within the MEA. One way to measure and report the amount of catalyst loading within the MEA is the ratio of mass of catalyst to geometric surface area of the MEA. Preferably, the ratio of mass of catalyst in the MEA to geometric surface area of the MEA is from about 0.05 mg catalyst/cm² to about 20 mg catalyst/cm².

Another way to measure catalyst loading is the ratio of the area of the PEM covered by the electrocatalyst material to the ratio of the PEM not covered by electrocatalyst material. This is best indicated by comparing the area of the catalyst layer in contact with the PEM to the total area of the PEM. As used herein, the “covered area” is the area of a face of the polygon created by a deposition pattern comprising electrocatalyst, wherein the face is parallel to the major plane of the PEM. As used herein, the “total covered area” is the sum of all covered areas. As used herein, the “total substrate area” is the area of a face of the PEM that is parallel to the major plane of the PEM. The “total uncovered area” is the total substrate area minus the total covered area. Preferably, the total uncovered area is at least 20% and more preferably at least 50% when expressed as a percentage of the total. If the loading of the electrocatalyst on the covered area is 1 mg catalyst/cm² and the uncovered area is 50% of the total, then the total loading becomes 0.5 mg catalyst/cm².

According to one embodiment of the present invention, a method for producing an MEA subassembly is provided. As used herein, a subassembly is any portion of the MEA that includes two or more components (e.g., layers), such as a CCM. Subassemblies can then be further processed to form a completed MEA. According to one aspect of the present embodiment, a spray device is used to deposit an ink composition on a substrate, e.g., PEM, to create an MEA subassembly, e.g., a CCM.

One preferred subassembly that can be manufactured in accordance with this embodiment of the present invention is a CCM. The method includes depositing one or more ink compositions on a PEM using a spray device, preferably in multiple spraying/vaporizing steps. In this method, a first ink composition including catalyst particles and PEI at predetermined concentrations is deposited on at least a portion of a PEM using a spray device to create a catalyst layer. A second ink composition comprising catalyst particles and PEI, optionally at a different concentration than the first ink composition, is deposited on at least a portion of the catalyst layer using a spray device to create a gradient in the composition. Immediately after the each layer is deposited, each layer can be passed through a vaporization region, which can be adjusted to completely remove the liquid from the layer at one extreme, or leave the liquid intact to enhance diffusion between the layers at the other extreme.

In another embodiment, the process employs two or more inks, which may be sprayed simultaneously with one another to form a single catalyst layer, or, alternatively, to form successive stacked layers. In this aspect, the inks may comprise compositionally different catalyst particles from one another or the same types of catalyst particles, but with some other variation, e.g., concentration, viscosity, PE particle concentration, etc. Thus, in one embodiment, the multiple stacked catalyst layers are formed on a membrane through alternating spraying and vaporizing steps, the multiple layers being formed from multiple inks, at least two of the multiple inks, respectively, comprising compositionally different catalyst particles form one another.

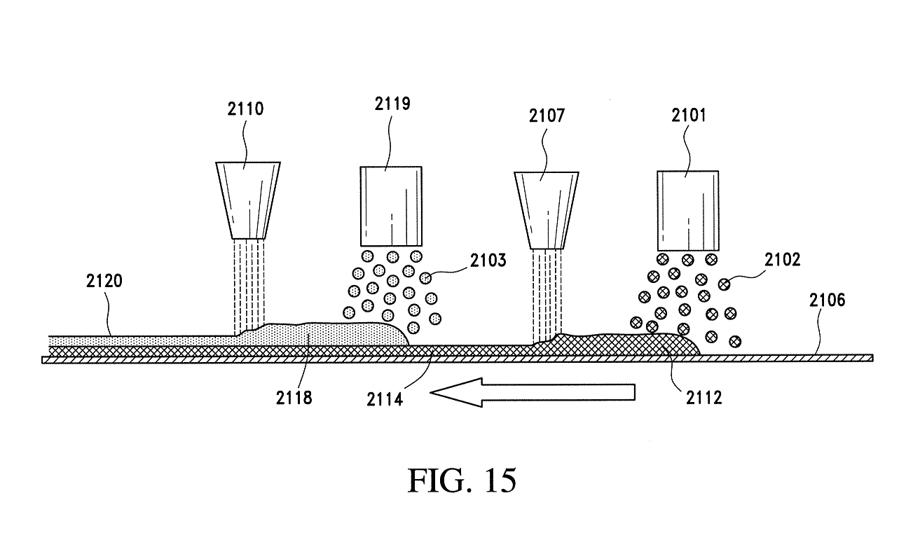

FIG. 15 illustrates a schematic view of one embodiment employing a spray assembly comprising multiple spray nozzles and multiple vaporization stations. In one embodiment a gradient composition layer can be deposited as follows. Spray nozzle 2101 delivers an ink with a first formulation 2102 to a substrate 2106. The deposited layer 2112 is wet and is processed 2107 by a number of possible different methods. The process 2107 may partially or fully dry the ink by heating to a temperature that vaporizes a portion of or substantially all of the vehicle. Optionally, the process 2107 may also heat the ink and induce chemical reactions such as thermal reaction of a Pt precursor to form Pt metal. In another embodiment, the process 2107 provides a form of radiation such as UV radiation that can cause chemical reactions and curing in the deposited layer 2112. After this step, the processed sublayer 2114 moves on the substrate under a second spray nozzle 2119, where an ink 2130 with a second formulation is delivered to deposit a layer 2118 onto the surface of processed sublayer 2114. The layer 2118 can then be processed by passing it under a second processing tool 2110, analogous to the processing effected by first processing tool 2107 to produce a processed layer 2120 on the surface of processed sublayer 2114. As can be appreciated, the ink formulations, processing conditions, spray devices and patterns can be varied according to the variables described throughout this invention to create a variety of desirable layer structures.

MEA Assembly

Once formed, a CCM can be packaged and shipped to customers who want to apply their own diffusion layers to form an MEA. Alternatively, the CCM's may be manufactured into MEA's and packaged and shipped as MEA's.

Alignment of the various materials and layers within the MEA is important prior to and during assembly of the MEA. As used herein, alignment means the relative position of differing materials, components, layers and other items within the MEA to each other and also between different components of the MEA structures. Typically, it is important to align gasket materials, diffusion layers and CCMs to achieve gas-tight and liquid-tight seals, which typically require a tolerance of ±500 μm.

As noted, a single spray device may deposit a single ink composition in a deposition pattern on a single side of a substrate, e.g., PEM. Subsequent deposition steps should ensure alignment with the previously deposited materials. With the processes of the present invention, deposition patterns created using a spray device are capable of being produced and aligned within ±100 μm of the desired alignment.

Alternatively, two or more spray devices may be used to deposit one or more ink compositions contemporaneously on either opposing sides or the same side of a substrate, e.g., PEM, in one or more deposition patterns. With the processes of the present invention, contemporaneously deposited first and second deposition patterns are capable of being produced and aligned within ±100 μm of the desired alignment.

In another instance, one or more subassemblies, as described below, should be aligned with another subassembly or bare substrate. A subassembly may comprise layers created from the deposition of ink compositions (e.g., a CCM) or may simply be a bare substrate such as a diffusion layer. When combining subassemblies with each other or with bare substrates, the layers within each subassembly should be aligned with the layers in the other subassemblies or substrates to achieve optimal performance. For example, a first subassembly comprising a first layer and a second subassembly comprising a second layer can be produced and the first and second subassemblies can be combined. With the method of the present invention, the first layer within the first subassembly and the second layer within the second subassembly are located within ±100 μm of the desired alignment, after the combining.

As used herein, a “bare substrate” is a substrate, such as a diffusion layer, that is substantially in its original state as received from its original equipment manufacturer, i.e., one that has not been contacted with an ink composition or other material.

After the appropriate subassemblies have been manufactured, it may be necessary to combine them to create the MEA where they have not been constructed in a single spraying process. Generally, the subassemblies are combined using lamination.

Lamination refers to the process where two or more substrates, e.g., a CCM and a diffusion layer, are bonded together using heat, pressure and/or an adhesive. In one embodiment of the present invention, a subassembly, created at least in part using a spray device, is combined with at least one of a second subassembly or a bare substrate. For example, the combined substrates can be aligned and pressed at a temperature of approximately 150° C. (for NAFION) and a pressure between 10 and 100 kg/cm² for a time between 1 second and 15 minutes.

In a preferred embodiment, a CCM is formed in a spray process according to the present invention. Prior to deposition of the ink composition, the spray nozzles of one or more spray devices and a PEM are aligned. One or more ink compositions are then contemporaneously deposited, e.g., sprayed, on opposing sides of the PEM using at least one spray nozzle to form the CCM. After the deposition is completed, the CCM subassembly is then sandwiched between two diffusion layers and pressed to form the MEA.

Frame-Based Approaches for Forming CCMs and MEAs

In a preferred aspect of the invention, the CCM or MEA is formed in a frame-based process, meaning a process that employs one or more membranes that are secured within a frame. In this aspect, prior to any steps of spraying, heating, or if described, pre- or post-conditioning, the membrane, e.g., PEM, is applied to a frame. The frame has several unique characteristics that assist in manufacturing membrane electrode assemblies of nearly any desired shape, optionally autonomously, and with little effort (e.g., manually or via fully automated software and computer controlled machines). Frames are preferably rigid and comprise alignment structures. The alignment structures can be one or more alignment pins or alignment holes (e.g., for receiving alignment pins), of any size or shape, or can be an optically reflective or transmittable material or device. The alignment structures provide positioning information useful for aligning the framed membrane with the manufacturing device or machine (e.g., platen, catalyst spraying equipment, diffusion layer mounting apparatus, etc.) so that during the manufacturing process, the manufacturing device or machine is capable of positionally performing an appropriate process on a desired region of the framed membrane. That is, the alignment structures provide a means whereby the position of the framed membrane is “known” relative to the manufacturing device or machine, such that the manufacturing device or machine is capable of directing the appropriate process to the appropriate location on the framed membrane. The alignment structures also optionally provide positioning information for one or more masks, described below, that may be implemented in the CCM or MEA manufacturing process. For example, in one aspect, the outer edge of a mask is aligned with the inner edge of the frame. In this manner, the inner edge of the frame acts as an alignment structure for receiving the outer edge (a second alignment structure) of the mask, thereby positioning the mask in a desired position relative to the membrane that is fixed within the frame.

Further still, the framed membrane can, as an assembly, be removably attached to a platen. A platen provides a firm fixture for the framed membrane, and preferably includes alignment structures such as fiducials, guide holes, and/or other indicia that are used by the manufacturing device or machine (e.g., catalyst spraying equipment, diffusion layer mounting apparatus, etc.) to locate the membrane and determine a substantially exact position over it. According to a preferred embodiment of the present invention, the framed membrane is removably secured to the platen is via vacuum means.

According to another embodiment of the present invention, masks are employed in a process for forming a CCM and/or an MEA. Masks may be used, for example, to define an area or region on an electrolyte membrane that is to be sprayed with a sprayable catalyst-containing ink to form one or more CCM's, much like a stencil. In this manner, the masks are used as guides for spraying the sprayable catalyst-containing ink onto an electrolyte membrane. If the process employs multiple sprayable inks, one or more than one mask may be employed as each respective layer is formed from the multiple inks.

Masks can be prepared using a variety of machining techniques, e.g., water cutting, laser cutting, and other standard machining techniques. Cathode masks and anode masks can be formed from a wide variety of materials, such as, for example, stainless steels, low VOC plastics, or aluminums. In some fuel cell designs, anode mask will be the same as or a mirror image of cathode mask, and in other designs, anode mask will be different. In some embodiments, multiple cathode masks and/or multiple anode masks may be employed, for example, to form a cathode catalyst layer and/or an anode catalyst layer having a catalyst gradient or an electrolyte (e.g., NAFION®) gradient (i.e., in the x, y and/or z directions).

The purpose of cathode mask is to allow a sprayable cathode catalyst-containing ink to be deposited onto a first surface of a membrane in a first area (or pattern) and to substantially prevent the sprayable cathode catalyst-containing ink from being deposited in a second area. Similarly, the purpose of anode mask is to allow a sprayable anode catalyst-containing ink to be deposited onto a second surface of the membrane in a third area (or pattern) and to substantially prevent the sprayable anode catalyst-containing ink from being deposited in a fourth area. Optionally, the first area is substantially the same pattern as the third area, and the second area is substantially the same pattern as the fourth pattern. In another aspect, the first area is the negative or inverse of the third area, and the second area is the negative or inverse of the fourth pattern. In still another aspect, the pattern of the first area is unrelated to the pattern of the third area, and the pattern of the second area is unrelated to the pattern of the fourth area. As discussed below, masks can be very simple in design (e.g., a single large open area, with a border portion), or can have nearly any imaginable design to create, for example, localized gradients of catalyst material as desired.

In another embodiment, the mask comprises a plurality of openings, each opening defining a separate CCM. As the catalyst ink is sprayed, multiple CCM's can be formed simultaneously. The multiple CCM's may later be separated by cutting, laser, or other conventional cutting means.

Masks and frame-based processes for forming CCM's and MEA's are further described in U.S. patent application Ser. No. 11/534,561, filed Sep. 22, 2006, the entirety of which is incorporated herein by reference.

### EXAMPLES

The present invention will be better understood in view of the following non-limiting examples.

### Example 1

### Preparation of Cathode Ink using Platinum, Nominally 60% on Carbon Black of Johnson Matthey Product Number 44171

Cathode ink was prepared as follows. 6 grams of deionized water was added to 1 gm of 60-wt % platinum on carbon. 3.53 grams of 5 wt. % NAFION® perfluorinated ion exchange resin solution (vehicle: lower aliphatic alcohol/water (20%) solution (EW1100) containing 2-propanol, 1-propanol and methanol) was then added to the mixture. The resulting mixture was horn sonicated in an ice bath for 10 minutes (750W, using 20% of maximum power). The ink stability was monitored using MICROTRAC® particle size distribution measurement. The ink viscosity was monitored using the VISCOMETER®. The PSD and viscosity as a function of time are tabulated in Table 2.

### Example 2

### Preparation of Cathode Ink using Platinum, Nominally 60% on Carbon Black of Cabot Corporation Product Number PPC965465F

A cathode ink was prepared as follows. 6 grams of deionized water was added to 1 gm of 60-wt% platinum on carbon. 3.53 grams of 5 wt. % NAFION® perfluorinated ion exchange resin solution (vehicle: lower aliphatic alcohol/water (20% ) solution (EW1100) containing 2-propanol, 1-propanol and methanol) was then added to the mixture. The resulting mixture was horn sonicated in an ice bath for 10 minutes (750W, using 20% of maximum power). The ink stability was monitored using MICROTRAC® particle size distribution measurement. The ink viscosity was monitored using the VISCOMETER®. The PSD and viscosity as a function of time are tabulated in Table 2.

### Example 3

### Preparation of Anode Ink using Platinum, Nominally 40% and Ruthenium Nominally 20% on Carbon Black of Cabot Corporation Product Number HPR375079A

Anode ink was prepared as follows. 8 grams of deionized water was added to 1-gram platinum/ruthenium black catalyst particles. The mixture was horn sonicated in ice at duty cycle 50 amplitude 20% for 10 minutes (750W, using 20% of maximum power). 3.53 grams of 5 wt. % NAFION® perfluorinated ion exchange resin solution (vehicle: lower aliphatic alcohol/water (20% ) solution (EW 1100) containing 2-propanol, 1-propanol and methanol) was then added to the mixture. The final mixture was again horn sonicated in ice, duty cycle 50 amplitude 20% for 5 minutes (750W, using 20% of maximum power). The ink stability was monitored using MICROTRAC® particle size distribution measurement. The ink viscosity was monitored using the VISCOMETER®. The PSD and viscosity as a function of time are tabulated in Table 2.

### Example 4

### Preparation of Cathode Ink using Platinum, Nominally 60% on Carbon Black of Cabot Corporation Product Number PP C966282

A cathode ink was prepared as follows. 54 grams of deionized water was added to 9 gm of 60-wt % platinum on carbon. 38.25 grams of 5 wt. % NAFIONO® perfluorinated ion exchange resin solution (vehicle: lower aliphatic alcohol/water (20% ) solution (EW1100) containing 2-propanol, 1-propanol and methanol) was then added to the mixture. The resulting mixture was sheared at 6000 rpm for 10 minutes using high shear Silverson Mixer® in an ice bath. The ink stability was monitored using MICROTRAC® particle size distribution measurement. The ink viscosity was monitored using the VISCOMETER®. The PSD and viscosity as a function of time are tabulated in Table 2.

### Example 5

### Preparation of Anode Ink using Platinum, Nominally 40% and Ruthenium Nominally 20% on Carbon Black of Cabot Corporation Product Number HPR375079A

Anode ink was prepared as follows. 54 grams of deionized water was added to 9 gm of 60-wt % platinum on carbon. 45 grams of 5 wt. % NAFION® perfluorinated ion exchange resin solution (vehicle: lower aliphatic alcohol/water (20% ) solution (EW1100) containing 2-propanol, 1-propanol and methanol) was then added to the mixture. The resulting mixture was sheared at 6000 rpm for 10 minutes using high shear Silverson Mixer® in an ice bath. The ink stability was monitored using MICROTRAC® particle size distribution measurement. The ink viscosity was monitored using the VISCOMETER®.

The PSD and viscosity of Examples 1-5 as a function of time are tabulated in Table 2, below.

TABLE 2
Ink Shelf Life

| Sample# | d(30) | d(50) | d(70) | d(90) | d(95) | Viscosity (cP) | Stability (hr) |
|---|---|---|---|---|---|---|---|
| Example 1 | 4.04 | 6.17 | 29.14 | 140.40 | 184.60 | 405* | 1.0 |
| Example 1 | 5.05 | 27.38 | 110.20 | 183.70 | 253.40 | 400* | 24.0 |
| Example 2 | 4.47 | 5.80 | 7.64 | 12.20 | 16.34 | 11.10 | 1.0 |
| Example 2 | 4.61 | 6.01 | 8.11 | 15.22 | 23.45 | 9.45 | 24.0 |
| Example 3 | 3.17 | 4.58 | 6.98 | 14.46 | 19.60 | 12.60 | 1.0 |
| Example 4 | 3.84 | 4.95 | 6.65 | 11.61 | 16.16 | 8.01 | 1.0 |
| Example 4 | 4.26 | 5.52 | 7.35 | 12.46 | 17.44 | 7.77 | 24.0 |
| Example 5 | 2.68 | 3.87 | 5.73 | 11.50 | 16.55 | 7.47 | 1.0 |
| Example 5 | 2.66 | 3.89 | 5.93 | 12.08 | 18.50 | 8.01 | 24.0 |

*Note: Viscosity was determined at 5 rpm instead of normal 100 rpm

### Example 6

### Solvent Evaporation Test

The ink from Example 4 was sprayed to form a multi-stacked catalyst layer comprising two catalyst layers, one deposited on the other, onto a framed NAFION® membrane using an ultrasonic spray nozzle. A portion of the vehicle in the first layer was allowed to vaporize prior to deposition of the second layer thereon. The membrane was heated on a heated-vacuum platen prior to spraying to a temperature of 70° C. and held at that temperature. The second catalyst layer was formed while the first catalyst layer was still wet (avg. 38% vehicle present) see Table 3, below. The weight of the membrane was determined before spraying, immediately after spraying of the ink to form the first layer, at 1 min, 2 min, 3 min thereafter, immediately after deposition of the second layer, and at 1 min, 2 min and 3 min thereafter. The results are shown in Table 3, below.

TABLE 3
Weight Analysis of Uncoated and Coated Membranes

| | | | | | | | Solids minus | % solvent left in |
|---|---|---|---|---|---|---|---|---|
| Pre weight | Post weight | Delta pre & | Drying time | | | 100% solids | total Solid and | ccm after each |
| Grams | Grams | post weight | 1 min | 2 min | 3 min | 0% solvent | Solvents | layer |
| 1 layer | | | | | | | | |
| 1.262 | 1.293 | 0.031 | 1.283 | 1.281 | 1.282 | 0.020 | 0.011 | 35 |
| 1.192 | 1.218 | 0.026 | 1.207 | 1.205 | 1.204 | 0.013 | 0.013 | 49 |
| 1.211 | 1.24 | 0.029 | 1.231 | 1.229 | 1.229 | 0.019 | 0.010 | 36 |
| 2 layer | | | | | | | | |
| 1.276 | 1.324 | 0.048 | 1.31 | 1.306 | 1.301 | 0.030 | 0.018 | 38 |
| 1.201 | 1.232 | 0.031 | 1.224 | 1.221 | 1.221 | 0.021 | 0.010 | 32 |

### Example 7

### Deposition of Electrode Layers on Membrane to form Catalyst Coated Membrane

The anode catalyst ink as described in Example 5 and cathode catalyst ink as described in Example 4 were used for deposition of electrode layers and preparation of a catalyst coated membrane (CCM). While not in use the catalyst ink formulations were constantly tumbled to eliminate settling and keep the suspension composition constant. A 50 cm² active area CCM using Nafion 115 membrane with anode loading of 3.0 mg PtRu/cm² and cathode catalyst loading of 1.5 mg Pt/cm² was prepared using the following procedure. The PEM membrane substrate was conditioned and clamped tightly inside a two-piece frame creating a taunt surface, which was heated at 70° C. while the deposition of the electrodes was conducted. 50 ml of the anode catalyst ink were loaded into a gas tight delivery spray syringe and the anode catalyst ink was sprayed using 15 deposition passes at each pass depositing layers at 7 mm spacing. The spray tip was positioned 25 mm above the membrane substrate and moved at a speed of 100 mm/sec. After the anode electrode was deposited, the frame was flipped over, and the cathode layer was sprayed. 50 ml of the cathode catalyst ink were loaded into a gas tight delivery spray syringe and the cathode catalyst ink was sprayed using 8 deposition passes at each pass depositing layers at 7 mm spacing.

The present invention has been described with reference to certain exemplary embodiments thereof. However, it will be readily apparent to those skilled in the art that it is possible to embody the invention in specific forms other than those of the exemplary embodiments described above. This may be done without departing from the spirit and scope of the invention. The exemplary embodiments are merely illustrative and should not be considered restrictive in any way. The scope of the invention is defined by the appended claims and their equivalents, rather than by the preceding description.

All United States patents and applications, foreign patents, and publications discussed above are hereby incorporated herein by reference in their entireties.

What is claimed is:

1. A sprayable ink, comprising:
(a) catalyst particles;
(b) polymer electrolyte ionomer; and
(c) a vehicle for dispersing the catalyst particles and the polymer electrolyte ionomer, wherein the catalyst particles have a d50 that does not increase by more than 10%, measured 24 hours after high shear mixing.

2. The sprayable ink of claim 1, wherein the ink has a total solids loading of from about 5 to about 20 weight percent.

3. The sprayable ink of claim 2, wherein the weight ratio of the catalyst particles to the polymer electolyte ionomer is greater than about 5:1.

4. The sprayable ink of claim 2, wherein at least a majority of the catalyst particles have a spherical morphology.

5. The sprayable ink of claim 4, wherein the ink has a viscosity not greater than about 25 cP.

6. The sprayable ink of claim 1, wherein the catalyst particles have an average particle size of from about 1 to about 10 microns.

7. The sprayable ink of claim 1, wherein the catalyst particles have an average particle size of from about 200 to about 1000 nanometers.

8. The sprayable ink of claim 7, wherein the catalyst particles comprise metal crystallites having an average crystallite size of less than about 10 nm.

9. The sprayable ink of claim 1, wherein the ink comprises the polymer electrolyte ionomer in an amount ranging from about 0.5 to about 5 weight percent.

10. The sprayable ink of claim 1, wherein the weight ratio of the catalyst particles to the polymer electolyte ionomer in the ink is from about 2 to about 10.

11. The sprayable ink of claim 1, wherein the vehicle is selected from the group consisting of: water, methanol, ethanol, propanol, 1-propanol, 2-propanol, glycols, ethylene glycols, propylene glycol, and combinations thereof.

12. The sprayable ink of claim 1, wherein the vehicle comprises water in an amount greater than about 60 wt. %.

13. The sprayable ink of claim 1, wherein the catalyst particles comprise a mixture of at least two different types of catalyst particles.

14. The sprayable ink of claim 1, wherein the polymer electrolyte ionomer comprises a sulfonated tetrafluorethylene copolymer.

15. The sprayable ink of claim 1, wherein the catalyst particles comprise at least one of an elemental metal or an alloy.

16. The sprayable ink of claim 1, wherein the catalyst particles comprise supported catalyst particles.

17. The sprayable ink of claim 1, wherein the catalyst particles comprise platinum.

18. The sprayable ink of claim 1, wherein the catalyst particles comprise an alloy of platinum and ruthenium.

19. A process for forming a catalyst coated membrane, comprising:
(a) depositing an ink comprising catalyst particles and a vehicle onto a membrane; and
(b) vaporizing from 40 to 90 weight percent of the vehicle from the sprayed ink under conditions effective to form a catalyst layer on the membrane, wherein steps (a) and (b) are alternated to form multiple stacked catalyst layers on the membrane.

20. The process of claim 19, wherein the catalyst particles in the ink have a d50 that does not increase by more than 10%, measured 24 hours after high shear mixing.

21. The process of claim 19, wherein the depositing comprises spraying.

22. The process of claim 19, wherein the vaporizing comprises heating the membrane.

23. The process of claim 19, wherein the process comprises controlling catalyst layer porosity by controlling the temperature of the membrane.

24. The process of claim 19, wherein the process further comprises the step of:
(c) controlling porosity in the multiple stacked catalyst layers by controlling the amount of vehicle vaporized in each alternating vaporizing step.

25. The process of claim 19, wherein the amount of vehicle vaporized in each alternating vaporizing step increases so as to create a porosity gradient in a direction perpendicular to a surface of the membrane.

26. The process of claim 19, wherein the amount of vehicle vaporized in each alternating vaporizing step decreases so as to create a porosity gradient in a direction perpendicular to a surface of the membrane.

27. The process of claim 19, wherein steps (a) and (b) are alternated at least five times.

28. The process of claim 19, wherein the membrane comprises a heated membrane.

29. The process of claim 19, wherein the membrane comprises a polymer electrolyte membrane.

30. The process of claim 19, wherein the spraying comprises aerosolizing the ink into a plurality of catalyst-containing droplets, the droplets having an average droplet size of from about 20 to about 60 microns.

31. The process of claim 19, wherein multiple stacked catalyst layers are formed on the membrane through alternating spraying and vaporizing steps, the multiple layers being formed from multiple inks, at least two of the multiple inks, respectively, comprising catalyst particles having different average particle sizes from one another.

32. The process of claim 19, wherein multiple stacked catalyst layers are formed on the membrane through alternating spraying and vaporizing steps, the multiple layers being formed from multiple inks, at least two of the multiple inks, respectively, comprising compositionally different catalyst particles from one another.

33. The process of claim 19, wherein the spraying comprises:
(i) spraying a first portion of the membrane with a first ink mixture comprising the liquid vehicle, a first catalyst amount of catalyst particles, and a first polymer electrolyte ionomer amount of polymer electolyte ionomer; and
(ii) spraying a second portion of the membrane with a second ink mixture comprising the liquid vehicle, a second catalyst amount of catalyst particles, and a second polymer electrolyte ionomer amount of polymer electolyte ionomer,
under conditions effective to form a catalyst gradient and/or polymer electrolyte ionomer gradient on the membrane.

34. The process of claim 33, wherein the gradient comprises a horizontal gradient.

35. The process of claim 33, wherein the gradient comprises a vertical gradient.

36. The process of claim 19, wherein the process forms a catalyst layer having a vertical gradient.

37. The process of claim 36, wherein the vertical gradient comprises a vertical porosity gradient.

38. The process of claim 36, wherein the vertical gradient comprises a particle size gradient.

39. The process of claim 36, wherein the vertical gradient comprises a catalyst particle concentration gradient.

40. The process of claim 19, wherein the gradient comprises a horizontal gradient.

41. The process of claim 40, wherein the horizontal gradient comprises a vertical porosity gradient.

42. The process of claim 40, wherein the horizontal gradient comprises a particle size gradient.

43. The process of claim 40, wherein the horizontal gradient comprises a catalyst particle concentration gradient.

44. The process of claim 19, wherein the ink has a total solids loading of from about 5 to about 20 weight percent.

45. The process of claim 19, wherein at least a majority of the catalyst particles have a spherical morphology.

46. The process of claim 45, wherein the ink has a viscosity not greater than about 25 cp.

47. The process of claim 19, wherein the catalyst particles have an average particle size of from about 1 to about 10 microns.

48. The process of claim 19, wherein the catalyst particles have an average particle size of from about 200 to about 1000 nanometers.

49. The process of claim 48, wherein the catalyst particles comprise metal crystallites having an average crystallite size of less than about 10 nm.

50. The process of claim 19, wherein the vehicle consists essentially of water.

51. The process of claim 19, wherein the catalyst particles comprise a mixture of at least two different types of catalyst particles.

52. The process of claim 19, wherein the catalyst particles comprise at least one of an elemental metal or an alloy.

53. The process of claim 19, wherein the catalyst particles comprise supported catalyst particles.

54. The process of claim 19, wherein the catalyst particles comprise platinum.

55. The process of claim 19, wherein the catalyst particles comprise an alloy of platinum and ruthenium.

56. The process of claim 19, wherein the process is repeated, optionally with a second ink, for the other side of the membrane.

57. A catalyst coated membrane formed by the process of claim 56.

58. A membrane electrode assembly comprising the catalyst coated membrane of claim 57.

59. A process for forming a catalyst coated membrane having a desired catalyst layer porosity, comprising:
(a) providing a correlation between catalyst layer porosity and membrane temperature;
(b) employing the correlation to determine a target membrane temperature based on the desired catalyst layer porosity;
(c) heating a membrane to the target membrane temperature; and
(d) depositing an ink comprising catalyst particles and a vehicle onto the heated membrane, wherein heated membrane vaporizes the vehicle and forms a catalyst layer having the desired catalyst layer porosity.

60. The process of claim 59, wherein the catalyst particles in the ink have a d50 that does not increase by more than 10%, measured 24 hours after high shear mixing.

61. The process of claim 59, wherein the depositing comprises spraying.

62. The process of claim 59, wherein step (d) is repeated in several passes to form multiple stacked catalyst layers.

63. A catalyst coated membrane comprising a polymer electrolyte membrane having a first surface and a first catalyst layer disposed thereon, wherein the first catalyst layer has a porosity gradient in which porosity increases in a direction extending away from the first surface.

64. The catalyst coated membrane of claim 63, wherein the polymer electrolyte membrane further comprises a second surface, the catalyst coated membrane further comprising a second catalyst layer disposed on the second surface.

65. The catalyst coated membrane of claim 63, wherein the first catalyst layer comprises polymer electolyte ionomer and catalyst particles.
